(19) United States
(12) Patent Application Publication
(10) Pub. No.: US 2026/0128973 A1
(43) Pub. Date: May 7, 2026

(54) DELAY STATUS REPORTS IN WIRELESS COMMUNICATIONS

(71) Applicant: Sharp Kabushiki Kaisha, Sakai City (JP)

(72) Inventors: Sangkyu BAEK, Vancouver, WA (US); Zhanping YIN, Vancouver, WA (US)

(21) Appl. No.: 18/940,466

(22) Filed: Nov. 7, 2024

(51) Int. Cl. H04L 43/0852; H04W 28/06; H04W 72/1268; H04W 80/02

(52) U.S. Cl. CPC H04L 43/0852; H04W 28/06; H04W 72/1268; H04W 80/02

(57) ABSTRACT

A transmitter node of a telecommunications system comprises processor circuitry and interface circuitry. The processor circuitry is configured to generate a truncated delay status report (DSR) medium access control (MAC) control element (CE). The truncated DSR MAC CE is configured to comprise only a subset of contents of a full DSR MAC CE. The interface circuitry is configured to transmit the truncated DSR MAC CE over a radio interface to a receiver node of the telecommunications system.

### TECHNICAL FIELD

The technology relates to wireless communications, and particularly to the reporting between network nodes, e.g., between a transmitter node and a receiver node, the presence of delay-critical data awaiting transmission.

### BACKGROUND

A radio access network typically resides between wireless devices, such as user equipment (UEs), mobile phones, mobile stations, or any other device having wireless termination, and a core network. Example of radio access network types includes the GRAN, GSM radio access network; the GERAN, which includes EDGE packet radio services; UTRAN, the UMTS radio access network; E-UTRAN, which includes Long-Term Evolution; and NG-UTRAN, the New Radio (NR).

A radio access network may comprise one or more access nodes, such as base station nodes, which facilitate wireless communication or otherwise provides an interface between a wireless terminal and a telecommunications system. A non-limiting example of a base station can include, depending on radio access technology type, a Node B (“NB”), an enhanced Node B (“eNB”), a home eNB (“HeNB”), a gNB (for a New Radio [“NR”] technology system), or some other similar terminology.

The 3rd Generation Partnership Project (“3GPP”) is a group that, e.g., develops collaboration agreements such as 3GPP standards that aim to define globally applicable technical specifications and technical reports for wireless communication systems. Various 3GPP documents may describe certain aspects of radio access networks. Overall architecture for a fifth-generation system, e.g., the 5G System, also called “NR” or “New Radio”, as well as “NG” or “Next Generation”, is shown in FIG. 1, and is also described in 3GPP TS 38.300. The 5G NR network is comprised of NG RAN (Next Generation Radio Access Network) and 5GC (5G Core Network). As shown, NGRAN is comprised of gNBs (e.g., 5G Base stations) and ng-eNBs (i.e. LTE base stations). An Xn interface exists between gNB-gNB, between (gNB)-(ng-eNB) and between (ng-eNB)-(ng-eNB). The Xn is the network interface between NG-RAN nodes. Xn-U stands for Xn User Plane interface and Xn-C stands for Xn Control Plane interface. An interface known as the NG interface exists between 5GC and the base stations (i.e. gNB & ng-eNB). A gNB node provides NR user plane and control plane protocol terminations towards the UE and is connected via the NG interface to the 5GC. The 5G NR (New Radio) gNB is connected to AMF (Access and Mobility Management Function) and UPF (User Plane Function) in 5GC (5G Core Network).

The Open Systems Interconnection, OSI, model is a reference framework that explains the process of transmitting data between computers. It is divided into seven layers that work together to carry out specialized network functions, allowing for a more systematic approach to networking. Information transferred from one device to another device travels through 7 layers of OSI model. First data travels down through 7 layers from the sender's end and then climbs back 7 layers on the receiver's end. Data flows through the OSI model in a step-by-step process:
Layer 7: Application Layer: Applications create the data.
Layer 6: Presentation Layer: Data is formatted and encrypted.
Layer 5: Session Layer: Connections are established and managed.
Layer 4: Transport Layer: Data is broken into segments for reliable delivery.
Layer 3: Network Layer: Segments are packaged into packets and routed.
Layer 2: Data Link Layer: Packets are framed and sent to the next device.
Layer 1: Physical Layer: Frames are converted into bits and transmitted physically.

A protocol stack may comprise different individual protocols. Protocols may be simply described as a set of rules that allow communication between peer entities or they can also be described as set of rules that facilitate horizontal communication. These protocols may be arranged in the layers such as those described above. In a transmitter side, a layer N receives data from layer N+1 and this data is called the SDU or Service Data Unit. This layer will modify the data and convert it into a PDU or a Protocol Data Unit. The peer entity in the receiver is only able to understand this PDU. In the receiver side, the peer entity receives the PDU from layer N−1, e.g., actually layer N−1 SDU, and converts it back into SDU(s) and passes it to layer N+1.

Radio Link Control (RLC) is a layer 2 Radio Link Protocol used in UMTS, LTE and 5G on the Air interface. This protocol is specified by 3GPP in TS 25.322 for UMTS, TS 36.322 for LTE and TS 38.322 for 5G New Radio (NR). RLC is located on top of the 3GPP MAC-layer and below the PDCP-layer. The main tasks of the RLC protocol are:
Transfer of upper layer Protocol Data Units (PDUs) in one of three modes: Acknowledged Mode (AM), Unacknowledged Mode (UM) and Transparent Mode (TM)
Error correction through ARQ (only for AM data transfer)
Segmentation and reassembly of RLC SDUs (UM and AM)
Re-segmentation of RLC data PDUs (AM)
Reordering of RLC data PDUs (UM and AM)
Duplicate detection (UM and AM)
RLC SDU discard (UM and AM)
RLC re-establishment
Protocol error detection and recovery

The Radio Resource Control (RRC) plays a role in managing the radio resources between the User Equipment (UE) and the 5G New Radio (NR) network.

In 3GPP New Radio (NR) standards, the Radio Link Control (RLC) sublayer supports reliable transmission based on an Automatic Repeat reQuest (ARQ) mechanism. RLC has three modes, namely (1) a Transparent Mode (TM), (2) an Unacknowledged Mode (UM) and (3) an Acknowledged Mode (AM). In the RLC AM mode, 100% successful delivery is guaranteed by multiple retransmissions. To guarantee 100% successful delivery, retransmissions should be performed even if the packet is already outdated, i.e., even if the packet was generated a long time ago, in which case it does not need to be processed at the destination or intermediate node. Retransmission of an outdated, e.g., obsolete packet, can be an inefficiency of RLC AM.

In Release 18 of 3GPP standards, a Delay Status Report, DSR, Medium Access Control, MAC, Control Element, CE, was introduced to inform the network that a wireless terminal, e.g., user equipment, UE, has delay-critical data. See, e.g., 3GPP TS 38.321 V18.3.0 (2024-09), 3rd Generation Partnership Project, Technical Specification Group Radio Access Network, NR, Medium Access Control (MAC) protocol specification (Release 18), which is incorporated herein by reference. A Delay Status Report Medium Access Control Control Element, DSR MAC CE, is an uplink control message transmitted by a User Equipment (UE) to the base station, e.g. gNB in 5G communications systems. Delay-critical data is defined as data with remaining time is below a threshold value, called a “remaining time threshold”, where remaining time is the time until the expiry of a Packet Data Convergence Protocol, PDCP, discard timer for service data unit, SDU, whose importance is not low. SDUs with low importance uses a different discard timer, so the SDUs with low importance is not considered as delay-critical data. The threshold value is configured by an RRC message transmitted from the base station to the UE.

FIG. 2 depicts a DSR format defined in 3GPP TS 38.321 V18.3.0 (2024-09). The MAC CE format consists of Logical Channel Group, LCG, bitmap, e.g., LCGi bitmap;

Remaining Time (RT) field; Buffer Size (BS) field; BT field; and reserved or R field. LCGi field indicates whether the set of the RT field and the BS field for the logical channel group, LCG, with LCG ID i is present or not. When the LCGi field is set to 1, the corresponding RT field and BS field for LCG with LCG ID i is present. When the LCGi field is set to 0, the corresponding RT field and BS field for the LCG with LCG ID i is omitted. The RT field indicates the shortest remaining value of running PDCP for the corresponding LCG. The BS field indicates the total amount of delay-critical data for the corresponding LCG. The BT field indicates the buffer size table to be used in the DSR MAC CE for the LCG. The BT field is set to 0 when a normal buffer size table is used. The BT field set to 1 indicates that a refined buffer size table for XR applications. The R field is a reserved field. The RT field and the BS field are codepoints which map to ranges of remaining time and buffer size, respectively.

As used herein, “buffer size” refers to the amount of contents in a buffer that is germane to an event, such as transmission of a DSR MAC CE, and not the overall capacity of a memory device in which the buffer is realized or hosted.

FIG. 3 depicts an example of a triggering event of a delay status report, DSR, and the corresponding contents of the delay status report. In the example of FIG. 3, a logical channel, LCH, e.g., LCH 2, is configured for a UE. The LCH 2 belongs to logical channel group shown as LCG3. The example of FIG. 3 shows that a packet (pkt) of 1000 bytes arrives at the UE. Its PDCP discard timer starts at the arrival of the packet. If there is a packet with remaining time below the remaining time threshold, a DSR is triggered. A DSR MAC CE is transmitted when the UE receives an uplink grant to accommodate the DSR MAC CE.

A DSR MAC CE indicates, e.g., an LCG which has delay-critical data, the shortest remaining time among stored data for the LCG, and buffer size of delay-critical data. The buffer size of the delay-critical data is also called “delay-critical data volume”. In the example of FIG. 3, the transmitted DSR indicated that LCG3 has delay-critical data. That LCG3 has delay-critical data is particularly indicated by a one-bit indication, LCG3, set to 1. For other LCGs, LCGi, their corresponding one-bit indications, LCGi, are set to 0. For LCG3, the reported remaining time, which is the shortest remaining time is y, the remaining time at the transmission time of the DSR. Buffer size is expressed as a codepoint for range of buffer size. According to 3GPP TS 38.321, 1000 bytes correspond to codepoint 74.

The DSR format shown in FIG. 2 supports only one set of RT field and BS field for an LCG. However, this information might not be sufficient for the network to schedule uplink resources to guarantee the quality of service, QoS, requirement. For example, a DSR MAC CE may include multiple sets of RT fields and BS fields for each LCG. As explained below, each LCG may have multiple zones determined by report thresholds. Each set of RT field and BS field requires at least 2 bytes, 16 bits, considering octet alignments. Reporting multiple sets increases the size of the DSR MAC CE which may result in additional resource waste. Moreover, DSR MAC CE is prioritized over data. This means that excessive resource usage of DSR MAC CE may result in delayed data transmission. Thus, a first problem with existing delay status report technology is a large size of the DSR when multiple sets of Remaining Time and Buffer Size for a logical channel group are included in a DSR MAC CE.

A second problem stems, e.g., from the fact that currently the buffer size field included in a DSR MAC CE considers only delay-critical data volume. This means that non-delay-critical data, e.g. data with low importance, is not considered. The wireless terminal transmits the buffered data on a first come/first served basis. If non-delay-critical data is ahead of the delay-critical data in the buffer, the wireless terminal transmits the non-delay-critical data before the delay-critical data. This may delay the transmission of delay-critical data. Since a DSR MAC CE does not provide any information on non-delay-critical data, the base station may not estimate the size of the uplink grant which the UE requires for transmission of all delay-critical data.

FIG. 4 depicts an example of the contents of a prior art DSR with multiple sets of remaining time and buffer size for an LCG in case that only delay-critical data is reported as a buffer size. The example assumes that 10 packets for LCG 3 are stored in the buffer. The status of packets is as follows:
Packet 1: high importance, 100 bytes, remaining time of 4 ms
Packet 2: low importance, 150 bytes, remaining time of 8 ms
Packet 3: low importance, 30 bytes, remaining time of 9 ms
Packet 4: high importance, 140 bytes, remaining time of 12 ms
Packet 5: low importance, 70 bytes, remaining time of 15 ms
Packet 6: low importance, 65 bytes, remaining time of 21 ms
Packet 7: high importance, 44 bytes, remaining time of 22 ms
Packet 8: low importance, 300 bytes, remaining time of 35 ms
Packet 9: high importance, 200 bytes, remaining time of 41 ms
Packet 10: low importance, 100 bytes, remaining time of 42 ms

The example scenario of FIG. 4 assumes that three zones are defined for DSR reporting of LCG 3. Zone 1 of LCG 3 is for data with remaining time between threshold 0, 0 ms, and threshold 1, 10 ms. Zone 2 of LCG 3 is for data with remaining time between threshold 1, 10 ms, and threshold 2, 30 ms. Zone 3 of LCG 3 is for data with remaining time between threshold 2, 30 ms, and threshold 3, 40 ms. The thresholds illustrated in FIG. 4 and other example embodiments and modes herein may differ depending on the particular scenario.

Zone 1 of LCG 3 has only one packet of delay-critical data with 100 bytes. The buffer size is 100 bytes and the shortest remaining time, e.g., the remaining time included in the DSR, is 4 ms. Zone 2 of LCG 3 has two packets of delay-critical data and the total buffer size is 184 bytes, i.e., 140+44 bytes. Its shortest remaining time is 12 ms. Zone 3 of LCG 3 does not have any delay-critical data. Thus, the buffer size is 0 and the shortest remaining time does not exist. If those buffer sizes of delay-critical data are reported in a DSR MAC CE, the base station may allocate an uplink grant of 288 bytes which is the sum of the reported buffer sizes of zone 1 and zone 2. However, 599 bytes (100+150+30+140+70+65+44) are required to transmit all delay-critical data which is packet 1, packet 4 and packet 7. The base station cannot calculate the exact amount of data that the wireless terminal, UE, needs to transmit all the stored delay-critical data. Inexact calculation of the amount of data that a wireless terminal needs for transmitting its stored delay-critical data may lead to insufficient uplink grants for such transmission.

What is needed are methods, apparatus, and/or techniques to address problems caused by or associated with existing delay status reports.

### SUMMARY

In a first of its example aspects the technology disclosed herein concerns a transmitter node of a telecommunications system. In an example embodiment and mode the transmitter node comprises processor circuitry and interface circuitry. The processor circuitry is configured to generate a truncated delay status report (DSR) medium access control (MAC) control element (CE). The truncated DSR MAC CE is configured to comprise only a subset of contents of a full DSR MAC CE. The interface circuitry is configured to transmit the truncated DSR MAC CE over a radio interface to a receiver node of the telecommunications system. Methods of operating such nodes are also provided.

The first example aspect may also include a receiver node of a communications system. In an example embodiment and mode the receiver node comprises interface circuitry and processor circuitry. The interface circuitry is configured to receive a truncated delay status report (DSR) medium access control (MAC) control element (CE) over a radio interface from a transmitter node of the telecommunications system. The processor circuitry is configured to determine from the truncated DSR MAC CE that the truncated DSR MAC CE comprises only a subset of contents of a full DSR MAC CE. Methods of operating such nodes are also provided.

In a second of its example aspects the technology disclosed herein concerns a transmitter node of a telecommunications system. In an example embodiment and mode the transmitter node comprises processor circuitry and interface circuitry. The processor circuitry is configured to generate a delay status report (DSR) medium access control (MAC) control element (CE). The DSR MAC CE comprises a buffer size field which includes non-delay-critical data in a buffer which precedes in transmission order delay-critical data reported by the DSR MAC CE. The interface circuitry is configured to transmit the DSR MAC CE over a radio interface to a receiver node of the telecommunications system. Methods of operating such nodes are also provided.

The second example aspect may also include a receiver node of a communications system. In an example embodiment and mode the receiver node comprises interface circuitry and processor circuitry. The interface circuitry is configured to receive a delay status report (DSR) medium access control (MAC) control element (CE) over a radio interface from a transmitter node of the telecommunications system. The processor circuitry is configured to determine from the DSR MAC CE a buffer size field which includes non-delay-critical data precedes, in reception order, delay-critical data reported by the DSR MAC CE. Methods of operating such nodes are also provided.

In a third of its example aspects the technology disclosed herein concerns a transmitter node of a telecommunications system. In an example embodiment and mode the transmitter node comprises processor circuitry and interface circuitry. The processor circuitry is configured to generate a delay status report (DSR) medium access control (MAC) control element (CE). The DSR MAC CE comprises an indication for which of plural zones of a logical channel group the DSR MAC CE comprises a set of information fields. The interface circuitry is configured to transmit the DSR MAC CE over a radio interface to a receiver node of the telecommunications system. Methods of operating such nodes are also provided.

The technology disclosed herein also includes a transmitter node of a communications system which generates and transmits an DSR MAC CE comprising an indication of whether a set of information fields comprises a buffer size field for delay-critical data and a separate buffer size field for non-delay-critical data. Methods of operating such nodes are also provided.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view of overall architecture for a 5G New Radio system.

FIG. 2 is a diagrammatic view of a delay status report format according to existing 3GPP standards.

FIG. 3 is a diagrammatic view depicting an example of a triggering event of a delay status report, DSR, and the corresponding contents of the delay status report.

FIG. 4 is a diagrammatic view depicting an example scenario in which contents of a delay status report comprises multiple sets of remaining time fields and buffer size fields for an LCG and in a case that only delay-critical data is reported as a buffer size.

FIG. 5 is a schematic view of selected, basic components of a communications system according to a first example aspect of the technology disclosed herein in which a transmitter node generates and transmits a truncated DSR MAC CE.

FIG. 6 is a diagrammatic view of representative acts or steps performed by the system of FIG. 5.

FIG. 7 is a diagrammatic view depicting an example of delay status for a transmitter node and truncated DSR MAC CE.

FIG. 8 is a schematic view showing in more detail an example implementation of a communications system in which a transmitter node generates and transmits a truncated DSR MAC CE.

FIG. 9 is a schematic view of selected, basic components of a communications system according to a second example aspect of the technology disclosed herein wherein a transmitter node generates and transmits a DSR MAC CE which comprises a buffer size field which includes non-delay-critical data in a buffer which precedes in transmission order delay-critical data reported by the DSR MAC CE.

FIG. 10 is a diagrammatic view of representative acts or steps performed by the system of FIG. 9.

FIG. 11 is a diagrammatic view depicting an example of buffer size calculation considering non-delay-critical data ahead of the last delay-critical data for the zone but not included in the buffer size of another zone.

FIG. 12 is a diagrammatic view depicting an example of buffer size calculation considering non-delay-critical data ahead of the first delay-critical data for the zone but not included in the buffer size of another zone.

FIG. 13 is a diagrammatic view depicting an example of buffer size calculation considering a sum of non-delay-critical and delay-critical data for a zone.

FIG. 14 is a schematic view showing in more detail an example implementation of a communications system in which a transmitter node generates and transmits a DSR MAC CE with a buffer size field which includes non-delay-critical data in a buffer which precedes in transmission order delay-critical data reported by the DSR MAC CE.

FIG. 15 is a schematic view of selected, basic components of a communications system according to a third example aspect of the technology disclosed herein wherein a transmitter node formats a DSR MAC CE.

FIG. 16 is a diagrammatic view depicting an example scenario and implementation a DSR MAC CE which is formatted whereby an LCGi bit indicates presence of at least one set of information fields BT/E/RT/BS set for LCG with LCG ID i.

FIG. 17 is a diagrammatic view depicting an example scenario and implementation of a DSR MAC CE which is formatted with a bitmap that indicates whether the DSR MAC CE includes the set of information fields for zones of the logical channel group

FIG. 18 is a diagrammatic view depicting an example scenario and implementation of a DSR MAC CE which is formatted with a first set of information fields for a logical channel includes a field that indicates whether the DSR MAC CE includes the set of information fields for another zone of the logical channel group.

FIG. 19 is a diagrammatic view depicting an example scenario and implementation of a DSR MAC CE which is formatted to comprise separate buffer size fields for delay-critical data and non-delay-critical data, respectively.

FIG. 20 is a schematic view showing in more detail an example implementation of a communications system in which a transmitter node generates and transmits a DSR MAC CE according to one or more formats of a third aspect of the technology disclosed herein.

FIG. 21 is a diagrammatic view showing example elements comprising electronic machinery which may comprise a wireless terminal, a radio access node, and a core network node according to an example embodiment and mode.

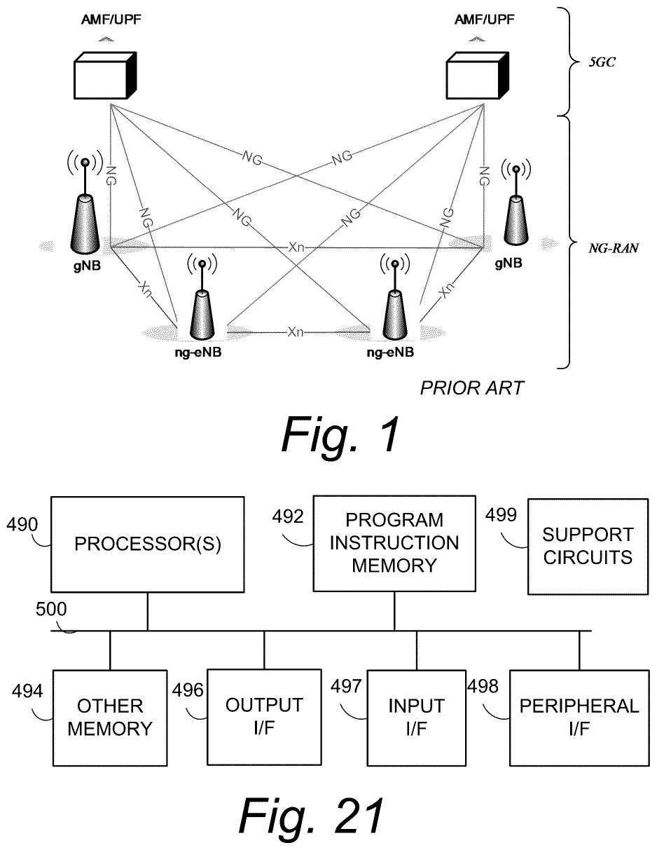

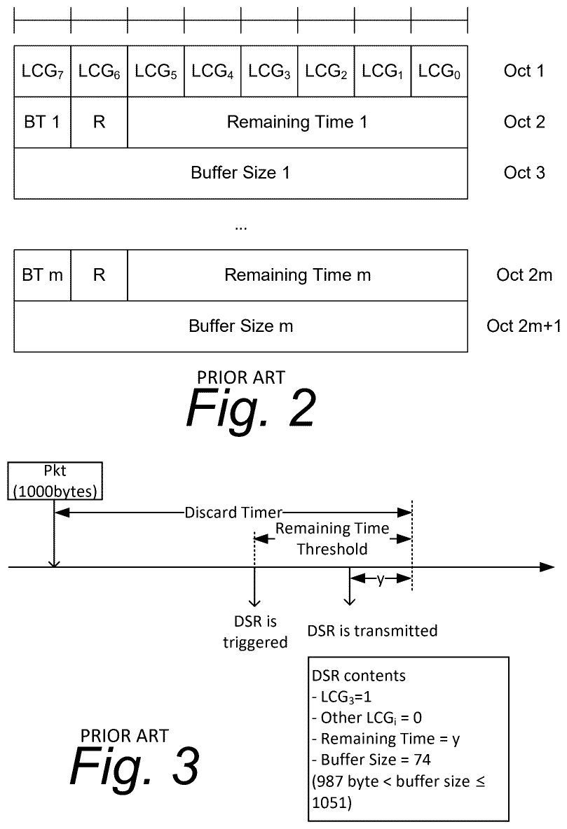

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. Those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudo code, and the like represent various processes which may be substantially represented in computer readable medium and so executed by a computer or processor, whether or not such computer or processor is explicitly shown.

As used herein, the term “telecommunication system” or “communications system” can refer to any network of devices used to transmit information. A non-limiting example of a telecommunication system is a cellular network or other wireless communication system. As used herein, the term “cellular network” or “cellular radio access network” can refer to a network distributed over cells, each cell served by at least one fixed-location transceiver, such as a base station. A “cell” may be any communication channel that is specified by standardization or regulatory bodies to be used for International Mobile Telecommunications-Advanced (“IMTAdvanced”); IMT-2020, e.g., 5G; IMT-2030, e.g., 6G, etc. All or a subset of the cell may be adopted by 3GPP as licensed bands (e.g., frequency band) to be used for communication between a base station, such as a Node B, and a UE terminal. A cellular network using licensed frequency bands can include configured cells. Configured cells can include cells of which a UE terminal is aware and in which it is allowed by a base station to transmit or receive information. Examples of cellular radio access networks include E-UTRAN, and any successors thereof (e.g., NUTRAN).

A core network (CN) may comprise numerous servers, routers, and other equipment. As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc. A core network may communicate over a RAN-CN interface (e.g., N2 interface) with one or more radio access networks (RAN).

A radio access network (RAN) may communicate with one or more core networks. A radio access network (RAN) typically comprises plural access nodes. As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”), a gNB (for a New Radio [“NR”] technology system), or some other similar terminology.

A radio access network (RAN) serves wireless terminals, which also form part of the radio access network (RAN). As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc.

A wireless terminal communicates with its serving radio access network (RAN) over a radio or air interface. Communication between radio access network (RAN) and wireless terminal over the radio interface occurs by utilization of “resources”. Any reference to a “resource” herein means “radio resource” unless otherwise clear from the context that another meaning is intended. In general, as used herein a radio resource (“resource”) is a time-frequency unit that can carry information across a radio interface, e.g., either signal information or data information.

Communication between the radio access network (RAN) 24 and wireless terminal over the radio interface 32 may occur on various layers. Layer 1 includes radio layer 1 or the physical layer. Higher layers, e.g., layers higher than Layer 1 may include radio layer 2 and radio resource control layer 3. The layer 1 communication may occur by utilization of “resources”. Reference to a “resource” herein means “radio resource” unless otherwise clear from the context that another meaning is intended. In general, as used herein a radio resource (“resource”) is a time-frequency unit that can carry information across a radio interface, e.g., either signal information or data information.

An example of a radio resource occurs in the context of a “frame” of information that is typically formatted and prepared, e.g., by a node. In Long Term Evolution (LTE) a frame, which may have both downlink portion(s) and uplink portion(s), is communicated between the base station and the wireless terminal. Each LTE frame may comprise plural subframes. For example, in the time domain, a 10 ms frame consists of ten one millisecond subframes. An LTE subframe is divided into two slots (so that there are thus 20 slots in a frame). The transmitted signal in each slot is described by a resource grid comprised of resource elements (RE). Each column of the two-dimensional grid represents a symbol (e.g., an OFDM symbol on downlink (DL) from node to wireless terminal; an SC-FDMA symbol in an uplink (UL) frame from wireless terminal to node). Each row of the grid represents a subcarrier. A resource element (RE) is the smallest time-frequency unit for downlink transmission in the subframe. That is, one symbol on one sub-carrier in the sub-frame comprises a resource element (RE) which is uniquely defined by an index pair (k,l) in a slot (where k and l are the indices in the frequency and time domain, respectively). In other words, one symbol on one sub-carrier is a resource element (RE). Each symbol comprises a number of sub-carriers in the frequency domain, depending on the channel bandwidth and configuration. The smallest time-frequency resource supported by the standard today is a set of plural subcarriers and plural symbols (e.g., plural resource elements (RE)) and is called a resource block (RB). A resource block may comprise, for example, 84 resource elements, i.e., 12 subcarriers and 7 symbols, in case of normal cyclic prefix

In 5G New Radio (“NR”), a frame consists of 10 ms duration. A frame consists of 10 subframes with each having 1 ms duration similar to LTE. Each subframe consists of 2^{μ} slots. Each slot can have either 14 (normal CP) or 12 (extended CP) OFDM symbols. A Slot is a typical unit for transmission used by scheduling mechanism. NR allows transmission to start at any OFDM symbol and to last only as many symbols as required for communication. This is known as “mini-slot” transmission. This facilitates very low latency for critical data communication as well as minimizes interference to other RF links. Mini-slots help to achieve lower latency in 5G NR architecture. Unlike slots, mini-slots are not tied to the frame structure. It helps in puncturing the existing frame without waiting to be scheduled. See, for example, https://www.rfwireless-world.com/5G/5G-NR-Mini-Slot.html, which is incorporated herein by reference.

In general, communication protocols between the wireless terminal and the telecommunication system may be categorized into Access Stratum (AS) and Non-Access Stratum (NAS). AS protocols, such as Radio Resource Control (RRC) and Medium Access Control (MAC), may be used for the wireless terminal to communicate with access nodes of a RAN, whereas NAS protocol(s), such as the NAS protocol specified in 3GPP TS 24.501, may be used for the wireless terminal to communicate with entities (e.g., AMF) of a CN(s), via access nodes of a RAN. Consequently, the wireless terminal may comprise a function to manage the AS protocols, and a separate function to manage the NAS protocol(s). Herein, terminology “NAS” may be used in some context to refer to the function built into the wireless terminal to manage the NAS protocol(s). Similarly, “RRC” may be used in some context to refer to the function built into the wireless terminal to manage the RRC protocol.

5G includes two cell group types: Master Cell Group (MSG) and Secondary Cell Group (SCG). The Master Cell Group is a group of serving cells associated with the Master RAN Node, comprising of the SpCell (Special Cell) which is known as the PCell (Primary Cell) and optionally one or more SCell (Secondary Cell). A PCell is used to initiate the initial access and considered as main cell in MCG. The Secondary Cell Group is a group of serving cells associated with the Secondary RAN Node, comprising of the SpCell which is known as the PSCell (Primary SCell) and optionally one or more SCells. UE might be configured with one or more SCell in connected mode. SCell can be activated or deactivated according to traffic.

### 1.0: Truncated Delay Status Reports

As indicated above, a first problem with existing delay status report technology is a large size of the DSR when multiple sets of Remaining Time and Buffer Size for a logical channel group are included in a DSR MAC CE. Section 1.0 of the technology disclosed herein concerns truncated delay status reports that address the first problem.

A truncated DSR, or truncated DSR MAC CE, is a delay status report that includes or reports a subset of full information to be reported by a DSR MAC CE, e.g., a subset of the full information that otherwise would be reported by a full DSR MAC CE. The truncated DSR MAC CE comprises only a subset of contents of a full DSR MAC CE, the truncated DSR MAC CE therefore lacks at least some contents of a full DSR MAC CE. A truncated DSR MAC CE can be transmitted in case that a DSR MAC CE cannot be transmitted due to the small size of an uplink grant or spare resource not used by any data or MAC CEs is expected.

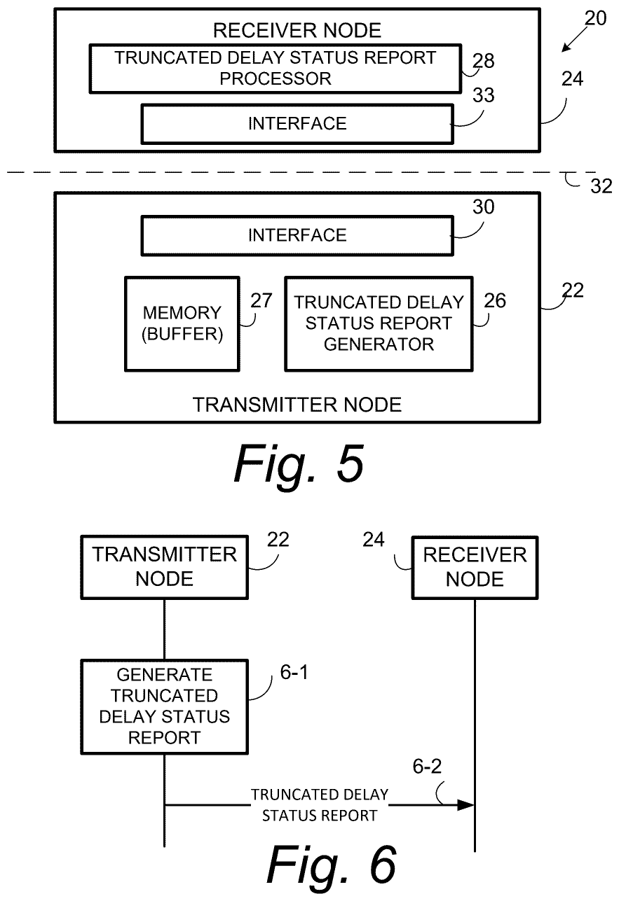

FIG. 5 shows an exemplary embodiment and mode of the technology disclosed herein in which a transmitter node generates and transmits a truncated DSR MAC CE. FIG. 5 shows a communications system 20 comprising transmitter node 22 and receiver node 24. The transmitter node 22 and receiver node 24 may also be referred to as a transmitting node and the receiver node may also be referred to as a receiving node. The transmitter node 22 comprises truncated delay status report generator 26 and memory 27. The receiver node 24 comprises truncated status report processor 28. The truncated delay status report generator 26 is configured to generate the truncated DSR MAC CE, e.g., upon receipt of an uplink grant having an uplink grant size that is smaller than size of the full DSR MAC CE. The truncated delay status report processor 28 is configured to determine from the truncated DSR MAC CE that the truncated DSR MAC CE comprises only a subset of contents of a full DSR MAC CE. The transmitter node 22 further comprises transmitter node interface 30, e.g., interface circuitry 30, which is configured to transmit the truncated DSR MAC CE over an air of radio interface 32 to an interface 33, e.g., receiver node interface circuitry 33 of the receiver node 24 of the telecommunications system.

FIG. 6 depicts example acts or steps which may be performed by the communications system 20 of FIG. 5. For example, in the method of FIG. 6 act 6-1 comprises generating a truncated delay status report (DSR) medium access control (MAC) control element (CE), the truncated DSR MAC CE comprising only a subset of contents of a full DSR MAC CE. Act 6-2 comprises transmitting the truncated DSR MAC CE over a radio interface to a receiver node of the telecommunications system.

Rationale for need of a truncated delay status report, e.g., the DSR MAC CE, and example embodiments and modes thereof, are described below.

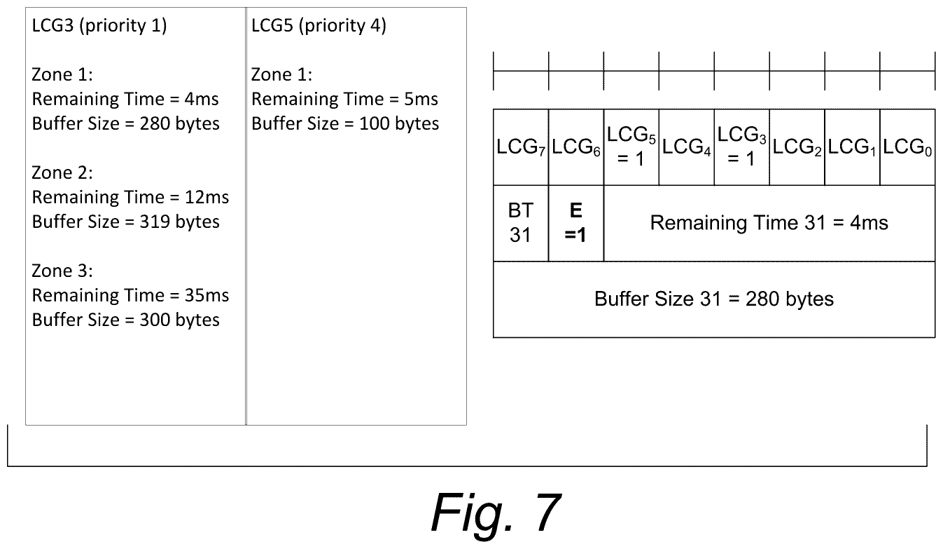

FIG. 7 depicts an example of delay status for a UE and truncated DSR MAC CE. The example of FIG. 7 assumes the existence and use of two logical channel groups, e.g., LCG 3 and LCG 5, e.g., assumes that both LCG 3 and LCG 5 are configured to a wireless terminal, UE. The logical channel group LCG 3 has a priority 1, which is the priority of the highest priority logical channel, LCH, of LCG 3. The logical channel group LCG 5 has priority 4, which is the priority of the highest priority LCH of LCG 5.

As mentioned above, transmitter node 22 further comprises memory 27. The memory 27 comprises a buffer wherein packets for the logical channel groups are stored. Each of the packets for the logical channel group are preferably classified in one of plural zones. The zones are differentiated, e.g., based on a remaining time for the packet in the buffer before discard of the packet from the buffer.

As shown in FIG. 7, LCG 3 has three zones for DSR reporting. Zone 1 of LCG 3 has buffer size of delay-critical data of 280 bytes and the shortest remaining time is 4 ms. Zone 2 of LCG 3 has buffer size of delay-critical data of 319 bytes and the shortest remaining time is 12 ms. Zone 3 of LCG 3 has buffer size of delay-critical data of 300 bytes and the shortest remaining time is 35 ms. LCG 5 has only one zone for DSR reporting which is Zone 1. Zone 1 of LCG 5 has buffer size of delay-critical data of 100 bytes and the shortest remaining time is 5 ms.

In the example embodiment and mode of FIG. 7, the LCGi bit indicates the presence of delay-critical data for LCG with LCG ID i, e.g., LCG i. The LCGi field set to 1 indicates that LCG i has delay-critical data. The LCGi field set to 0 indicates that LCG i does not have delay-critical data. Thus, in the example embodiment and mode of FIG. 7, the first octet of the DSR MAC CE essentially comprises a bitmap which indicates one or more logical channel groups (LCGs) comprising delay critical data.

For LCGs with its LCGi field set to 1, the set of fields BT/E/RT/BS set can be presented in a predetermined order of LCG identifiers. For example, the set of fields may be presented or arranged in an ascending order of LCG ID. In another example embodiment, for LCGs with its LCGi field set to 1, the set of fields BT/E/RT/BS may be presented in decreasing order of priority of the highest priority LCH of the LCG. In case of equal priority, the field set BT/E/RT/BS can be presented in ascending order of LCG ID. Within the same LCG, the set of fields BT/E/RT/BS for the each zone can be presented in ascending order of reporting threshold.

As used herein, a “set of information fields” and “set of fields” are interchangeable and preferably comprises at least a remaining time field and a buffer size field. Typically but not necessarily the set of fields comprises the BT/E/RT/BS fields described above. The set of fields BT/E/RT/BS may also be described as the BT/E/RT/BS field. In an exemplary implementation, E field or BT field can be replaced by R (reserved) field.

The example embodiment and mode of FIG. 7 assumes that only one set of fields BT/E/RT/BS can be presented in the DSR MAC CE due to the resource allocation. The delay status report of FIG. 7 is thus a truncated delay status report, e.g., truncated DSR MAC CE, since it does not include sets of fields for all zones of the logical channel group. Since LCG 3 and LCG 5 both have delay-critical data, the LCG3 field and LCG5 field of the bitmap of the first octet are set to 1. Among LCG 3 and LCG 5, LCG 3 has the higher priority. Since the resource allocation is limited, e.g., since the size remaining in an uplink grant for the delay status report is smaller than the size of the full delay status report, only a set of fields BT/E/RT/BS set for LCG 3 can be included. The truncated delay status report generator 26 is configured to select the selected one(s) of the one or more logical groups based on size of an uplink grant which is smaller than the size of the full DSR MAC CE.

As such, in the example embodiment and mode of FIG. 7 the LCG 3 is the LCG which is selected for inclusion in the truncated DSR MAC CE. In other situations, two or more LCGs, or two or more zones, may be included in the truncated DSR MAC CE, depending on the size of the uplink grant and the number of LCGs/zones. The one or more logical channel groups that may be included in the truncated DSR MAC CE are herein referred to also as a selected LCG. That is, the truncated delay status report generator 26 is configured to generate the truncated DSR MAC CE to comprise a set of information fields for the selected one(s) of the one or more logical channel groups.

Moreover, in the example embodiment and mode of FIG. 7 only a set of fields for one zone of LCG 3 can be included in the truncated DSR MAC CE. Within LCG 3, Zone 1 has delay-critical data with the smallest remaining time. Thus, in view of the size of the uplink grant, only the set of fields BT/E/RT/BS for Zone 1 of LCG 3 is included in the DSR MAC CE.

Therefore, with reference to the system 20 of FIG. 5, for the situation depicted in FIG. 7 and as act 6-1 of FIG. 6, the truncated delay status report generator 26 of transmitter node 22 generates a truncated DSR MAC CE.

Since Zone 2 and Zone 3 of the LCG 3 of FIG. 7 have delay-critical data, the truncated delay status report generator 26 sets the E field of the truncated DSR MAC CE for Zone 1 to 1. The “E” field, which also may be referred to as an “extension field”, thus indicating that the LCG 3, which is the subject of the truncated DSR MAC CE of FIG. 7, has further zones with delay-critical data.

The receiver node interface circuitry 33 receives the truncated DSR MAC CE over the radio interface 32 from the transmitter node 22. Based on the information included in the truncated DSR MAC CE, such as LCG bitmap of the first octet and the E field being set to 1, the receiver node 24 is able to understand that the delay status report is a truncated delay status report and thus includes only a subset of information that would have been included in a full DSR MAC CE had the uplink resources permitted transmission of the full DSR MAC CE. For example, from the LCG bitmap of the first octet of the truncated DSR MAC CE the truncated delay status report processor 28 is able to discern that LCG 5 also has delay-critical data that cannot and is not reported in sets of information fields of the truncated DSR MAC CE. Moreover, from the “E” field the truncated delay status report processor 28 is able to discern that either one or both of Zone 2 and Zone 3 of LCG 3 may have delay-critical data, although detailed remaining time and buffer size for Zone 2 and Zone 3 of LCG 3 are not reported in the truncated DSR MAC CE in view of uplink grant constraints.

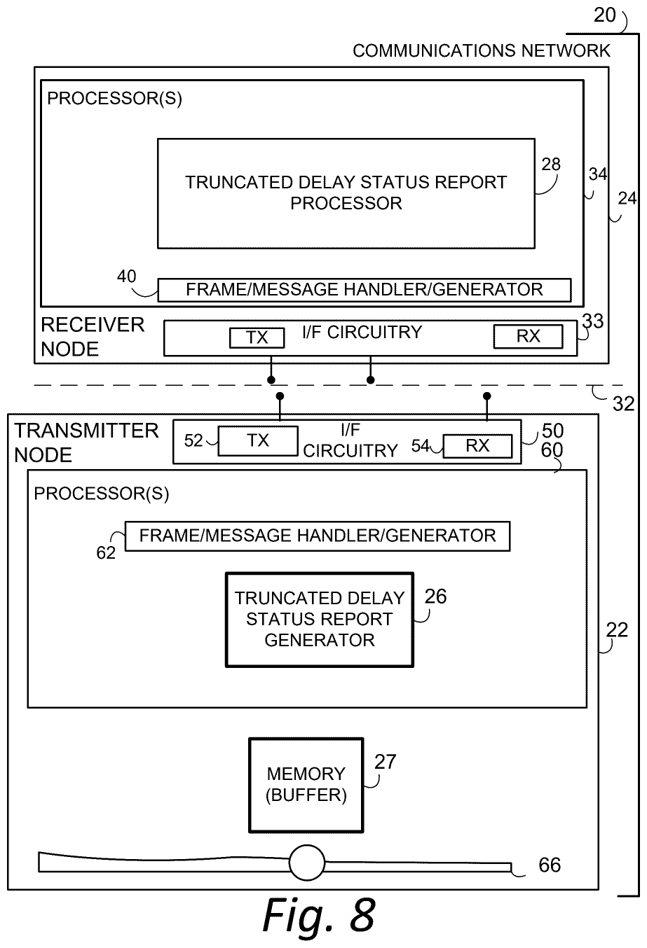

FIG. 8 shows in more detail an example communications system in a transmitter node generates and transmits a truncated DSR MAC CE. The example units and functionalities illustrated in FIG. 8 are not limiting, e.g., various units and functionalities may be omitted in some implementations and other units and functionalities not illustrated herein may be included.

FIG. 8 shows the receiver node 24 comprising receiver node processor circuitry which may comprise one or more receiver node processors 36, as well as the aforementioned receiver node transceiver circuitry 33, which may also be referred to as receiver node interface circuitry. As illustrated in FIG. 8, the receiver node's transceiver circuitry 33 may be a transmission and reception point (TRP). The transmission and reception point (TRP) 33 may further comprise transmitter circuitry and receiver circuitry. The receiver node processors 36 may comprise various entities including the truncated delay status report processor 28 and receiver node frame/message handler/generator 40. The node frame/message handler/generator 40 prepares and generates information including user data and messages, e.g., signaling, for transmission over the radio interface 32, and which also processes information received over the radio interface 32. The receiver node processors 36 may also comprise or realize various other entities or functionalities, such as an unillustrated radio link control, RLC, entity

FIG. 8 also shows various example constituent components and functionalities of transmitter node 22. In an example embodiment and mode, the transmitter node 22 may be a wireless terminal such as a user equipment unit, for example. For example, FIG. 8 shows transmitter node 22 as comprising memory 27 and transmitter node transceiver circuitry 30, which was illustrated as interface 30 in FIG. 5. The transmitter node transceiver circuitry 30 may also be referred to as transmitter node interface circuitry 30. The transceiver circuitry 30 in turn may comprise transmitter circuitry 52 and receiver circuitry 54. The transmitter node transceiver circuitry 30 may include antenna(e) for the wireless transmission. Transmitter circuitry 52 may include, e.g., amplifier(s), modulation circuitry and other conventional transmission equipment. Receiver circuitry 54 may comprise, e.g., amplifiers, demodulation circuitry, and other conventional receiver equipment.

FIG. 8 further shows transmitter node 22 also comprising transmitter node processor circuitry, e.g., one or more transmitter node processor(s) 60. The transmitter node 22, e.g., transmitter node processor(s) 60, may comprise the previously mentioned truncated delay status report generator 26 and transmitter node frame or message handler/generator 62. The transmitter node 22 may also comprise user interfaces 66, including one or more user interfaces. Such user interfaces may serve for both user input and output operations, and may comprise (for example) a keyboard, a mouse, a screen such as a touch screen that can both display information to the user and receive information entered by the user. The user interface 66 may also include other types of devices, such as a speaker, a microphone, or a haptic feedback device, for example.

The first example aspect of the technology disclosed herein including in section 1.0 hereof also encompasses generation and transmission of a Truncated DSR, e.g., truncated DSR MAC CE, as well as interpretation of LCGi field and E field and order of RT/BS field when the truncated DSR is used, such as illustrated by FIG. 6, for example.

Example features of the first example aspect of the technology disclosed herein including in section 1.0 hereof include but are not limited to the following:
A truncated DSR MAC CE is transmitted to indicate subset of full contents of DSR MAC CE.
A truncated DSR MAC CE is transmitted when a remaining size of an uplink grant is smaller than that of full DSR MAC CE.
LCGi bit indicates presence of delay-critical data for LCG with LCG ID i (1: present, 0: absent)
(BT)/(E)/RT/BS set can be presented in ascending order of LCG ID for LCGi field set to 1.
Within the same LCG, (BT)/(E)/RT/BS set can be presented in ascending order of reporting threshold of each zone.

The first example aspect of the technology disclosed herein including section 1.0 hereof also encompasses a computer program product in which processor circuitry or the like, such as transmitter node processor(s) 60, which may include truncated delay status report generator 26, and receiver node processor(s) 36, which may include truncated delay status report processor 28, execute instructions stored on a non-transient memory to perform acts such as those above described, including the acts of FIG. 6.

### 2.0: Delay Status Reports Which Reflect Impactful Non-Delay-Critical Data

As indicated above, a second problem with existing delay status report technology is the impact of non-delay-critical data ahead of delay-critical data in the transmission of the delay-critical data. Section 2.0 of the technology disclosed herein concerns delay status reports that address the second problem by reflecting or taking into account impactful non-delay-critical data.

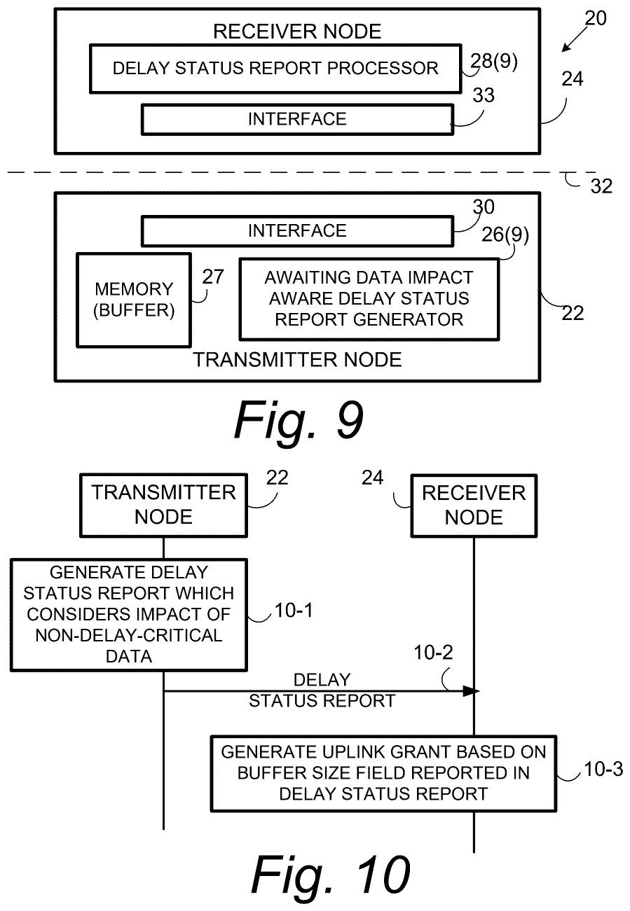

FIG. 9 shows an exemplary embodiment and mode of the technology disclosed herein in which a transmitter node generates and transmits a DSR MAC CE delay status report which reflects or takes into account impactful non-delay-critical data. FIG. 9 shows a communications system 20 comprising transmitter node 22 and receiver node 24. The transmitter node 22 and receiver node 24 may also be referred to as a transmitting node and the receiver node may also be referred to as a receiving node. The transmitter node 22 comprises delay status report generator 26(9) and memory 27. The receiver node 24 comprises delay status report processor 28(9). The delay status report generator 26(9) is configured to generate the DSR MAC CE to comprise a buffer size field that includes non-delay-critical data which precedes in transmission order delay-critical data reported by the DSR MAC CE. A buffer size field that “includes” non-delay-critical data includes a field that takes into consideration in the numerical value of the buffer size field both the delay-critical data in the buffer and the amount of non-delay-critical data in the buffer that precedes in transmission order the delay-critical data in the buffer. In other words, for example, the delay status report generator 26(9) generates a DSR MAC CE which considers, in reporting of buffer content size, the impact of non-delay-critical data which is stored in the buffer and which must precede the delay-critical data reported by the DSR MAC CE. The delay status report generator 26(9) therefore may be termed, as shown in FIG. 9, an awaiting data impact aware delay status report generator. In examples described herein, the delay status report generator 26(9) may be configured to generate the delay status report (DSR) medium access control (MAC) control element (CE) to comprise a buffer size field for one or more zones for at least one of the one or more logical channel groups reported by the DSR MAC CE; the buffer size field reflects an amount of delay-critical data for the zone and an amount of non-delay-critical data.

The transmitter node 22 further comprises transmitter node interface 30, e.g., interface circuitry 30, which is configured to transmit the DSR MAC CE over an air of radio interface 32 to an interface 33, e.g., receiver node interface circuitry 33 of the receiver node 24 of the telecommunications system.

The receiver node 24 of FIG. 9 comprises interface circuitry, e.g., receiver node interface circuitry 33, and delay status report processor 28(9). The receiver node interface circuitry 33 is configured to receive a delay status report (DSR) medium access control (MAC) control element (CE) over a radio interface 32 from the transmitter node 22.

FIG. 10 depicts example acts or steps which may be performed by the communications system 20 of FIG. 9. For example, in the method of FIG. 10, act 10-1 comprises generating a delay status report (DSR) medium access control (MAC) control element (CE) which comprises an indication of non-delay-critical data in the buffer which precedes in transmission order delay-critical data reported by the DSR MAC CE. For example, act 10-1 may comprise generating the DSR MAC CE to comprise a buffer size field for one or more zones for at least one of the one or more logical channel groups reported by the DSR MAC CE. For at least one of the zones, the buffer size field reflects an amount of delay-critical data for the zone and an amount of non-delay-critical data. Act 10-2 comprises transmitting the DSR MAC CE over the radio interface 32 to a receiver node, such as receiver node 24 of the telecommunications system. Act 10-3, which is optional, comprises the receiver node 24 generating an uplink grant for the transmitter node 22 in consideration of the buffer size field reported by the DSR MAC CE received at act 10-3.

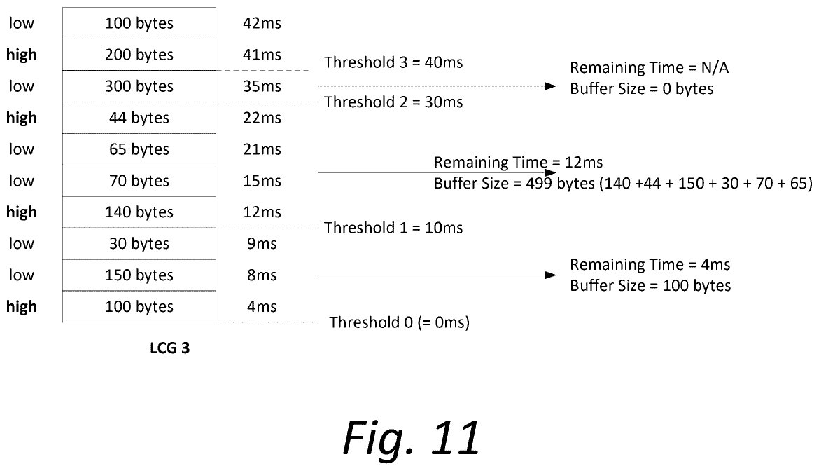

FIG. 11 depicts an example scenario of buffer size calculation considering non-delay-critical data ahead of delay-critical data. The example scenario of FIG. 11 assumes that 10 packets for LCG 3 are stored in the buffer. The status of packets is as follows:
Packet 1: high importance, 100 bytes, remaining time of 4 ms
Packet 2: low importance, 150 bytes, remaining time of 8 ms
Packet 3: low importance, 30 bytes, remaining time of 9 ms
Packet 4: high importance, 140 bytes, remaining time of 12 ms
Packet 5: low importance, 70 bytes, remaining time of 15 ms
Packet 6: low importance, 65 bytes, remaining time of 21 ms
Packet 7: high importance, 44 bytes, remaining time of 22 ms
Packet 8: low importance, 300 bytes, remaining time of 35 ms
Packet 9: high importance, 200 bytes, remaining time of 41 ms
Packet 10: low importance, 100 bytes, remaining time of 42 ms

The example scenario of FIG. 11 assumes that three zones are defined for DSR reporting of LCG 3. Zone 1 of LCG 3 is for data with remaining time between threshold 0, 0 ms, and threshold 1, 10 ms. Zone 2 of LCG 3 is for data with remaining time between threshold 1, 10 ms, and threshold 2 (30 ms). Zone 3 of LCG 3 is for data with remaining time between threshold 2, 30 ms., and threshold 3, 40 ms. It should be appreciated that other time values may be used for the thresholds depending on the scenario.

In accordance with a second aspect of the technology disclosed herein and Section 2.0 hereof, a buffer size (BS) field of the DSR MAC CE is generated to include (1) amount of delay-critical data for the zone and (2) the amount of non-delay-critical data which may impact the delivery of the delay-critical data for the zone.

In one or more example embodiments and modes of Section 2.0, receiver node 24, e.g., a base station, may send an appropriate message, such as an RRC message, to configure at the transmitter node 22 whether to consider the non-delay-critical data in calculation of the buffer size. In such example embodiments and modes, the wireless terminal 30 may be further configured to receive a configuration message over the radio interface from receiver node 24, and the delay status report generator 26(9) may be configured to generate the DSR MAC CE to include buffer size of non-delay-critical data in the buffer based on the configuration message.

In an example, non-limiting implementation of the second aspect of the technology disclosed herein, and as illustrated in the scenario of FIG. 11, the amount of non-delay-critical data may comprise non-delay-critical data stored in the buffer timewise ahead of the last delay-critical data for the zone but included in the buffer size of another zone.

In the example scenario of FIG. 11, Zone 1 of LCG 3 has only one packet of delay-critical data with 100 bytes. The buffer size is 100 bytes and the shortest remaining time, i.e. remaining time included in the DSR, is 4 ms. Zone 2 of LCG 3 has two packets of delay-critical data and the amount of delay-critical data is 184 bytes (144+40). Packet 2 (150 bytes), Packet 3 (30 bytes), Packet 5 (70 bytes) and Packet 6 (65 bytes) are delay-critical data ahead of Packet 7 (44 bytes), the last delay-critical data of Zone 2 of LCG 3, and have not been reported as any buffer size field. Thus, this amount (150+30+70+65) can be added to the buffer size of Zone 2. The buffer size of Zone 2 of LCG 3 can be calculated as 499 bytes. The remaining time of Zone 2 can be 12 ms which only considers the shortest remaining time of delay-critical data of Zone 2. Zone 3 does not have any delay-critical data. Thus, the buffer size is 0 and the shortest remaining time does not exist. Thus, the BT/E/RT/BS field for Zone 3 of LCG 3 can be omitted. Based on the information, the base station may calculate the exact amount of data that the UE need to transmit all the stored delay-critical data.

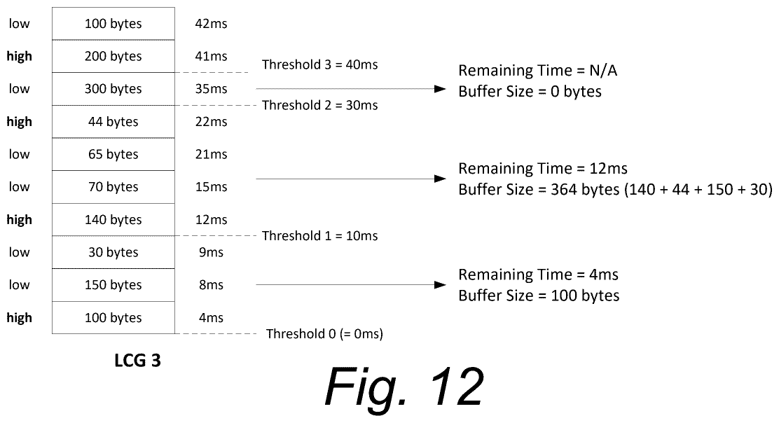

In an example, non-limiting implementation of the second aspect of the technology disclosed herein, and as illustrated in the scenario of FIG. 11, the amount of non-delay-critical data may comprise non-delay-critical data stored in the buffer timewise ahead of the first delay-critical data for the zone but included in the buffer size of another zone. The example scenario of FIG. 12 assumes that 10 packets for LCG 3 are stored in the buffer. The status of packets for FIG. 12 is as follows:
Packet 1: high importance, 100 bytes, remaining time of 4 ms
Packet 2: low importance, 150 bytes, remaining time of 8 ms
Packet 3: low importance, 30 bytes, remaining time of 9 ms
Packet 4: high importance, 140 bytes, remaining time of 12 ms
Packet 5: low importance, 70 bytes, remaining time of 15 ms
Packet 6: low importance, 65 bytes, remaining time of 21 ms
Packet 7: high importance, 44 bytes, remaining time of 22 ms
Packet 8: low importance, 300 bytes, remaining time of 35 ms
Packet 9: high importance, 200 bytes, remaining time of 41 ms
Packet 10: low importance, 100 bytes, remaining time of 42 ms

The example scenario of FIG. 12 assumes that three zones are defined for DSR reporting of LCG 3. Zone 1 of LCG 3 is for data with remaining time between threshold 0, 0 ms, and threshold 1, 10 ms. Zone 2 of LCG 3 is for data with remaining time between threshold 1, 10 ms, and threshold 2, 30 ms. Zone 3 of LCG 3 is for data with remaining time between threshold 2, 30 ms, and threshold 3, 40 ms. As previously stated, other threshold values may be utilized.

Thus, in the example implementation of FIG. 12, the buffer size (BS) field includes (1) amount of delay-critical data for the zone and (2) the amount of non-delay-critical data which may impact the delivery of the delay-critical data for the zone. More specifically, for the FIG. 12 implementation the amount of non-delay-critical data which may impact the delivery of the delay-critical data for the zone means that non-delay-critical data stored in the buffer timewise ahead of the first delay-critical data in the zone but not included in the buffer size of another zone.

The base station may send an RRC message which configures whether to consider the non-delay-critical data in calculation of the buffer size.

In the FIG. 12 scenario and implementation, Zone 1 of LCG 3 has only one packet of delay-critical data with 100 bytes. The buffer size is 100 bytes and the shortest remaining time, i.e. remaining time included in the DSR, is 4 ms. Zone 2 of LCG 3 has two packets of delay-critical data and the amount of delay-critical data is 184 bytes (144+40). Packet 2 (150 bytes), and Packet 3 (30 bytes) are delay-critical data ahead of Packet 4 (140 bytes), the first delay-critical data of Zone 2 of LCG 3, and have not been reported as any buffer size field. Thus, this amount (150+30) can be added to the buffer size of Zone 2 of LCG 3. The buffer size of Zone 2 of LCG 3 can be calculated as 364 bytes. The remaining time of Zone 2 of LCG 3 can be 12 ms which only considers the shortest remaining time of delay-critical data of Zone 2. Zone 3 of LCG 3 does not have any delay-critical data. Thus, the buffer size is 0 and the shortest remaining time does not exist. Thus, the BT/E/RT/BS field for Zone 3 of LCG 3 can be omitted. Based on the information, the base station may calculate the exact amount of data that the UE needs to transmit all the stored delay-critical data, as in act 10-4, for example.

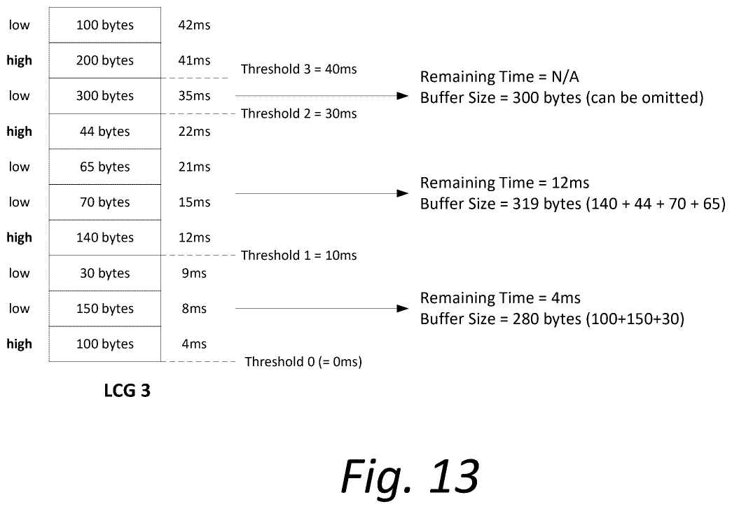

FIG. 13 depicts a further example scenario and implementation of buffer size calculation according to the second aspect of the technology disclosed herein, e.g., according to Section 2.0 hereof. The example scenario and implementation of FIG. 13 also considers non-delay-critical data ahead of delay-critical data as a buffer size reported in a DSR MAC CE, and particularly considers the amount of non-delay-critical data as being the delay-critical data for the zone. The example scenario and implementation of FIG. 13 assumes that 10 packets for LCG 3 are stored in the buffer. The status of packets for the FIG. 13 scenario is as follows:
Packet 1: high importance, 100 bytes, remaining time of 4 ms
Packet 2: low importance, 150 bytes, remaining time of 8 ms
Packet 3: low importance, 30 bytes, remaining time of 9 ms
Packet 4: high importance, 140 bytes, remaining time of 12 ms
Packet 5: low importance, 70 bytes, remaining time of 15 ms
Packet 6: low importance, 65 bytes, remaining time of 21 ms
Packet 7: high importance, 44 bytes, remaining time of 22 ms
Packet 8: low importance, 300 bytes, remaining time of 35 ms
Packet 9: high importance, 200 bytes, remaining time of 41 ms
Packet 10: low importance, 100 bytes, remaining time of 42 ms

The example scenario and implementation of FIG. 13 assumes that three zones are defined for DSR reporting of LCG 3. Zone 1 of LCG 3 is for data with remaining time between threshold 0, 0 ms, and threshold 1,10 ms. Zone 2 of LCG 3 is for data with remaining time between threshold 1, 10 ms, and threshold 2, 30 ms. Zone 3 of LCG 3 is for data with remaining time between threshold 2, 30 ms, and threshold 3, 40 ms.

In the example scenario and implementation of FIG. 13, the buffer size (BS) field may include amount of both delay-critical data and non-delay-critical data for the zone. The base station may send an RRC message which configures whether to consider the non-delay-critical data in calculation of the buffer size. In another exemplary embodiment, a DSR MAC CE format may include separate buffer size fields for delay-critical data and non-delay-critical data for each zone.

In the FIG. 13 example scenario, Zone 1 of LCG 3 has only one packet of delay-critical data with 100 bytes. The buffer size is calculated as 280 bytes by considering both delay-critical data (Packet 1) and non-delay-critical data (Packet 2). Its shortest remaining time (i.e. remaining time included in the DSR) is 4 ms which is the shortest remaining time of delay-critical data for the zone. Zone 2 of LCG 3 has two packets of delay-critical data and the amount of delay-critical data is 184 bytes (144+40). Also, the amount of non-delay-critical data is 135 bytes (70+65). The buffer size of Zone 2 of LCG 3 can be calculated as 319 bytes. The remaining time of Zone 2 of LCG 3 can be 12 ms which only considers the shortest remaining time of delay-critical data of Zone 2 of LCG 3. Zone 3 of LCG 3 does not have any delay-critical data. The buffer size is calculated as 300 bytes considering the amount of non-delay-critical data and the shortest remaining time does not exist. Thus, BT/E/RT/BS field for Zone 3 of LCG 3 can be omitted. Based on the information, the base station may calculate the exact amount of data that the UE need to transmit all the stored delay-critical data.

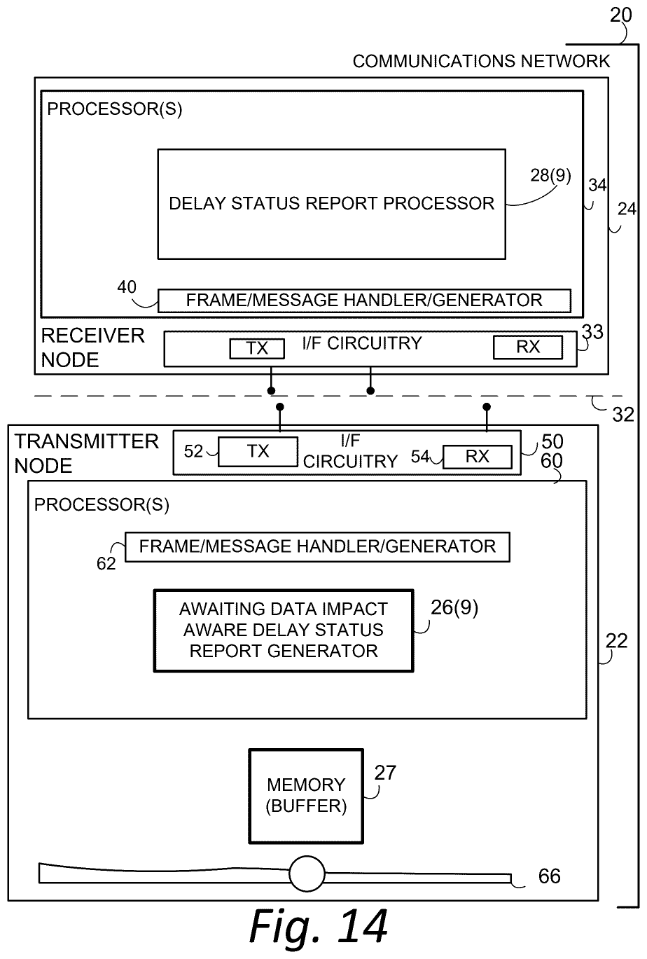

FIG. 14 shows in more detail an example implementation of a communications system in which a transmitter node generates and transmits a DSR MAC CE which comprises a buffer size field that includes the amount of non-delay-critical data in a buffer which precedes in transmission order delay-critical data reported by the DSR MAC CE. The example units and functionalities illustrated in FIG. 14 are not limiting, e.g., various units and functionalities may be omitted in some implementations and other units and functionalities not illustrated herein may be included.

FIG. 14 shows the receiver node 24 comprising receiver node processor circuitry which may comprise one or more receiver node processors 36, as well as the aforementioned receiver node transceiver circuitry 33, which may also be referred to as receiver node interface circuitry. As illustrated in FIG. 14, the receiver node's transceiver circuitry 33 may be a transmission and reception point (TRP). The transmission and reception point (TRP) 33 may further comprise transmitter circuitry and receiver circuitry. The receiver node processors 36 may comprise various entities including the delay status report processor 28(9) and receiver node frame/message handler/generator 40. The node frame/message handler/generator 40 prepares and generates information including user data and messages, e.g., signaling, for transmission over the radio interface 32, and which also processes information received over the radio interface 32. The receiver node processors 36 may also comprise or realize various other entities or functionalities, such as an unillustrated radio link control, RLC, entity

FIG. 14 also shows various example constituent components and functionalities of transmitter node 22. In an example embodiment and mode, the transmitter node 22 may be a wireless terminal such as a user equipment unit, for example. For example, FIG. 14 shows transmitter node 22 as comprising memory 27 and transmitter node transceiver circuitry 30, which was illustrated as interface 30 in FIG. 5. The transmitter node transceiver circuitry 30 may also be referred to as transmitter node interface circuitry 30. The transceiver circuitry 30 in turn may comprise transmitter circuitry 52 and receiver circuitry 54. The transmitter node transceiver circuitry 30 may include antenna(e) for the wireless transmission. Transmitter circuitry 52 may include, e.g., amplifier(s), modulation circuitry and other conventional transmission equipment. Receiver circuitry 54 may comprise, e.g., amplifiers, demodulation circuitry, and other conventional receiver equipment.

FIG. 14 further shows transmitter node 22 also comprising transmitter node processor circuitry, e.g., one or more transmitter node processor(s) 60. The transmitter node 22, e.g., transmitter node processor(s) 60, may comprise the previously mentioned delay status report generator 26(9) and transmitter node frame or message handler/generator 62. The transmitter node 22 may also comprise user interfaces 66, including one or more user interfaces. Such user interfaces may serve for both user input and output operations, and may comprise (for example) a keyboard, a mouse, a screen such as a touch screen that can both display information to the user and receive information entered by the user. The user interface 66 may also include other types of devices, such as a speaker, a microphone, or a haptic feedback device, for example.

The first example aspect of the technology disclosed herein including section 2.0 hereof also encompasses Calculation of Buffer Size for DSR by Considering Non-Delay-Critical Data; reporting delay-critical data and non-delay-critical data ahead of the last delay-critical data, as shown in the example embodiment and mode of FIG. 11; reporting delay-critical data and non-delay-critical data ahead of the first delay-critical data, as shown in the example embodiment and mode of FIG. 12; and, report a sum of delay-critical data and non-delay-critical data, as shown in the example embodiment and mode of FIG. 13.

Example features of the second example aspect of the technology disclosed herein including section 2.0 hereof include but are not limited to the following:
The buffer size field in DSR MAC CE includes amount of delay-critical data for the zone and amount of non-delay-critical data which gives an impact to the delay-critical data for the zone.
The non-delay-critical data which gives an impact to the delay-critical data for the zone is non-delay-critical data ahead of the last delay-critical data in the zone.
The non-delay-critical data which gives an impact to the delay-critical data for the zone is non-delay-critical data ahead of the first delay-critical data in the zone.
The non-delay-critical data is not included in BS field if it has already included in BS field of another zone in the same DSR MAC CE.

The second first example aspect of the technology disclosed herein including section 2.0 hereof also encompasses a computer program product in which processor circuitry or the like, such as transmitter node processor(s) 60, which may include delay status report generator 26(9), and receiver node processor(s) 36, which may include delay status report processor 28(9), execute instructions stored on a non-transient memory to perform acts such as those above described, including the acts of FIG. 10.

### 3.0: Example DSR MAC CE Formats

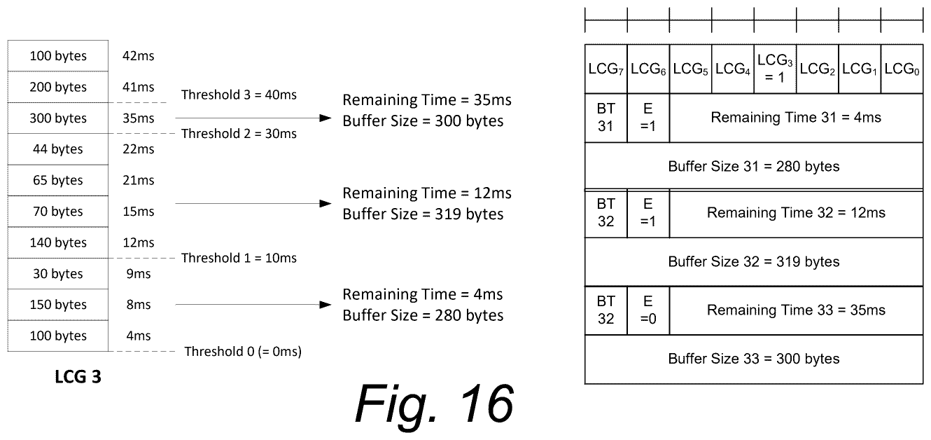

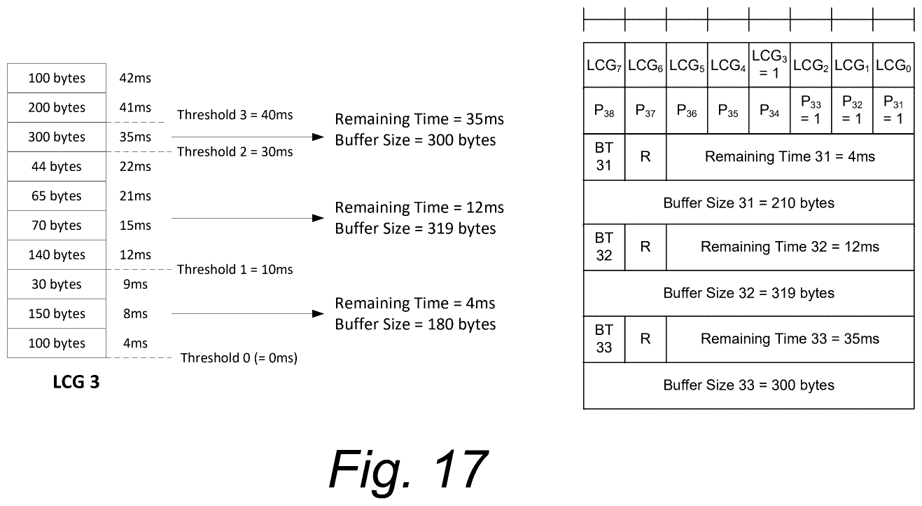

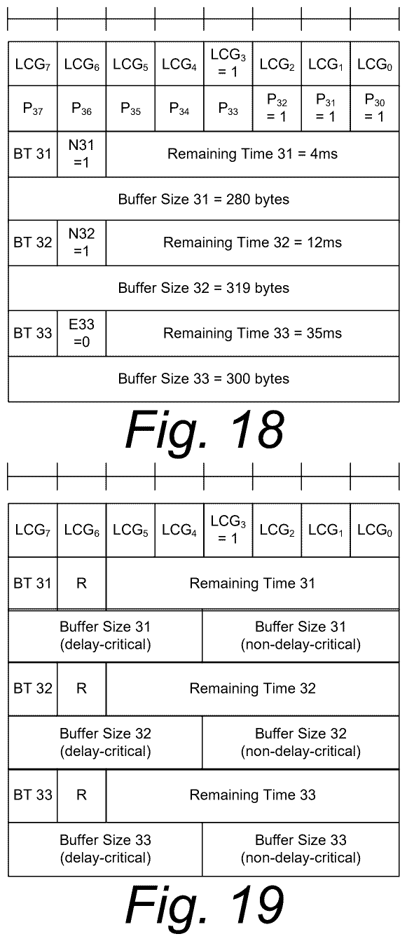

A third aspect of the technology disclosed herein concerns example formats for DSR MAC CEs. Numerous example formats are described herein and encompassed hereby, including but not limited to the DSR MAC CE formats illustrated in FIG. 16, FIG. 17, FIG. 18, and FIG. 19.

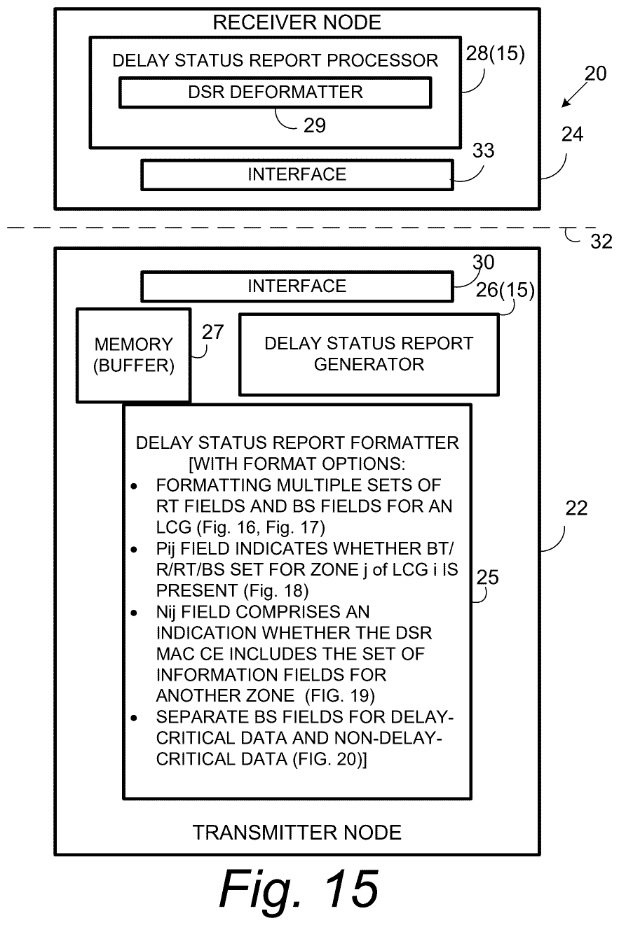

FIG. 15 shows an exemplary embodiment and mode of the technology disclosed herein in which a transmitter node formats a DSR MAC CE delay status report. FIG. 15 shows a communications system 20 comprising transmitter node 22 and receiver node 24. The transmitter node 22 and receiver node 24 may also be referred to as a transmitting node and the receiver node may also be referred to as a receiving node. The transmitter node 22 comprises delay status report formatter 25, delay status report generator 26(15), and memory 27.

The transmitter node 22 further comprises transmitter node interface 30, e.g., interface circuitry 30, which is configured to transmit the DSR MAC CE over an air of radio interface 32 to an interface 33, e.g., receiver node interface circuitry 33 of the receiver node 24 of the telecommunications system.

The receiver node 24 of FIG. 15 comprises interface circuitry, e.g., receiver node interface circuitry 33, delay status report processor 28(15), and delay status report deformatter 29. The receiver node interface circuitry 33 is configured to receive a delay status report (DSR) medium access control (MAC) control element (CE) over a radio interface 32 from the transmitter node 22. The delay status report deformatter 29 is configured to deformat the received DSR MAC CE and thereby facilitate the work of the delay status report processor 28(15).

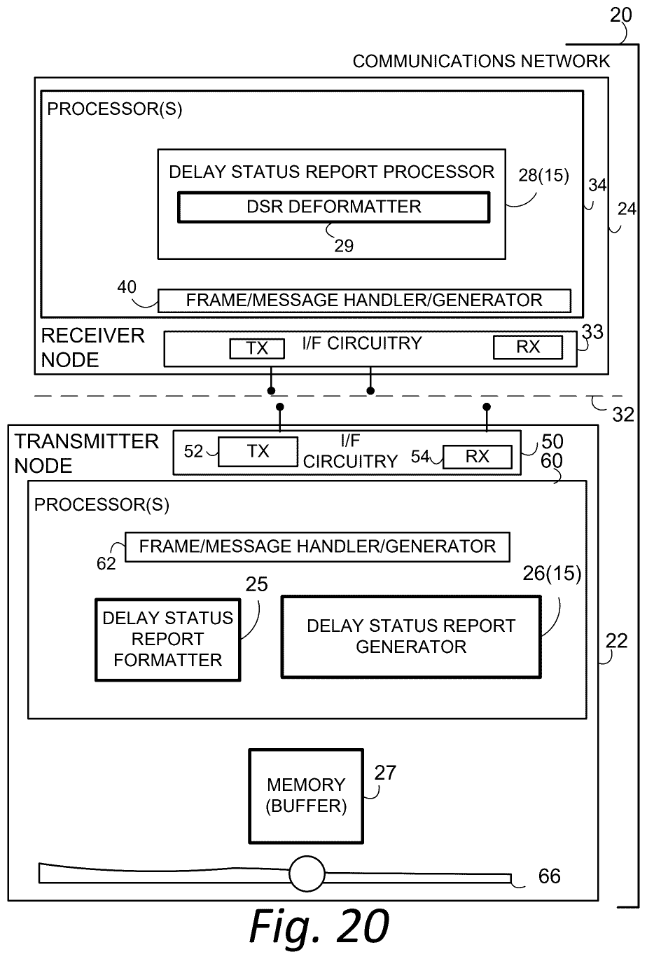

The delay status report formatter 25 is depicted in FIG. 15 to include several formatting options and/or alternatives, such as the following:
Formatting multiple sets of RT fields and BS fields for an LCG, as described with reference to FIG. 16, for example.
Formatting multiple sets of RT fields and BS fields for an LCG (FIG. 16, FIG. 17)
Pij field indicates whether BT/R/RT/BS set for Zone j of LCG i is present (FIG. 18)
Nij field comprises an indication whether the DSR MAC CE includes the set of information fields for another zone (FIG. 19)
separate BS fields for delay-critical data and non-delay-critical data (FIG. 20)

FIG. 16 depicts an example scenario and implementation of delay status for a UE and a DSR MAC CE. The example of FIG. 16 assumes that one logical channel group, LCG 3, is configured for a wireless terminal, UE. LCG 3 has three zones for DSR reporting. Unlike in the preceding figures, all the packets of FIG. 16 are assumed to be delay-critical. Zone 1 of LCG 3 has buffer size of delay-critical data of 280 bytes and the shortest remaining time is 4 ms. Zone 2 of LCG 3 has buffer size of delay-critical data of 319 bytes and the shortest remaining time is 12 ms. Zone 3 of LCG 3 has buffer size of delay-critical data of 300 bytes and the shortest remaining time is 35 ms. Unlike in the preceding figures, LCG 5 does not have any delay-critical data.

In the example embodiment and mode of FIG. 16 the delay status report formatter 25 uses or formats the LCGi bit to indicate presence of at least one BT/E/RT/BS set for LCG with LCG ID i, LCG i. The LCGi field set to 1 indicates that the DSR MAC CE includes at least one BT/E/RT/BS set for the LCG i. LCGi field set to 0 indicates that the DSR MAC CE does not include BT/E/RT/BS set for the LCG i. For LCGs with its LCGi field set to 1, BT/E/RT/BS set can be presented in ascending order of LCG ID. Within the same LCG, BT/E/RT/BS set for the each zone can be present in ascending order of reporting threshold.

BT/E/RT/BS set for zone without any delay-critical data is not present. In other words, only BT/E/RT/BS set for zone with any delay-critical data is included in the MAC CE. E field indicates whether the next BT/E/RT/BS field is for the same LCG. In the example, E field set to 1 indicates that the next BT/E/RT/BS field is for the same LCG and E field set to 0 indicates that the next BT/E/RT/BS field is for different LCG or there is no further BT/E/RT/BS field. E field for any LCG with only one zone, i.e. one threshold except threshold 0 is configured, is always set to 0. In an exemplary embodiment, the meaning of E bit set to 0 and 1 can be swapped.

Thus, FIG. 16 illustrates an example of a DSR format with multiple sets of RT field and BS field for an LCG. The example of FIG. 16 shows that the BT/E/RT/BS field for Zone 1 is present first, that the BT/E/RT/BS field for Zone 2 thereafter follows, and that the BT/E/RT/BS field for Zone 3 follows after the fields for Zone 2. The E fields for Zone 1 and Zone 2 are set to 1, to indicate, e.g., that at least one set of information fields for another zone follows. However, the E field for Zone 3 is set to 0, as there is no further BT/E/RT/BS field for LCG 3.

FIG. 17 depicts an example of a DSR MAC CE with multiple sets of RT fields and BS fields for an LCG. In the example of FIG. 17, the same packet arrivals, the same remaining time, and the same remaining time threshold of FIG. 16 are assumed. The example format of FIG. 17 includes a characteristic or format feature that a Pij field indicates whether BT/R/RT/BS set for Zone j of LCG i is present in the DSR MAC CE. The Pij field set to 1 indicates that BT/R/RT/BS set for Zone j of LCG i is present in the DSR MAC CE. Pij field set to 0 indicates that BT/R/RT/BS set for Zone j of LCG i is not present in the DSR MAC CE. For LCGs with LCGi field set to 1, Pij bitmap can be presented in the MAC CE in ascending order of LCG ID. For LCGs with LCGi field set to 0, Pij bitmap is not presented in the MAC CE. For Zone j with Pij field set to 1, BT/E/RT/BS set for the each zone can be present in ascending order of reporting threshold. For the example of FIG. 17, LCG5 is assumed not to have any delay-critical data.

Thus, in the example of FIG. 17, the processor circuitry, e.g., delay status report generator 26(15) working with delay status report formatter 25, generates the DSR MAC CE to comprise at least (1) a first set of information fields for a first zone of a logical channel group reported by the DSR MAC CE; and (2) an indication whether the DSR MAC CE includes a set of information fields for another zone of the logical channel group. In the example format of FIG. 17, the indication whether the DSR MAC CE includes a set of information fields for another zone of the logical channel group comprises a bitmap, Pij, corresponding to the plural zones, and with the DSR MAC CE including the set of information fields for zones of the logical channel group according to the bitmap.

The example of FIG. 17 shows that BT/E/RT/BS field for Zone 1 is present first, that for Zone 2 is followed, and that for Zone 3 is followed.

FIG. 18 depicts an example of a DSR MAC CE with multiple sets of RT field and BS field for an LCG. The example of FIG. 18 includes a format feature or a characteristic that a Nij field indicates whether BS field for this zone includes non-delay-critical data. Nij field set to 1 indicates that BS field for this zone includes non-delay-critical data. Nij field set to 0 indicates that BS field for this zone does not include non-delay-critical data. The exact calculation of the BS field considering non-delay-critical data may follow the BS calculation rule of exemplary embodiment of FIGS. 11, 12, or 13.

In another exemplary embodiment, a Nij field may indicate whether BS field for this zone includes non-delay-critical data which impacts data delivery of delay-critical data. An Nij field set to 1 may indicate that BS field for this zone includes non-delay-critical data which impacts data delivery of delay-critical data. An Nij field set to 0 may indicate that BS field for this zone does not include non-delay-critical data which impacts data delivery of delay-critical data.

Thus, in the example of FIG. 18, the processor circuitry, e.g., delay status report generator 26(15) working with delay status report formatter 25, generates the DSR MAC CE to comprise at least (1) a first set of information fields for a first zone of a logical channel group reported by the DSR MAC CE; and (2) an indication whether the DSR MAC CE includes a set of information fields for another zone of the logical channel group. In the example format of FIG. 18, the first set of information fields, e.g., the Nij field, comprises the indication whether the DSR MAC CE includes the set of information fields for another zone of the logical channel group.

FIG. 19 depicts an example of a DSR MAC CE with multiple sets of RT fields and BS fields for an LCG. The example of FIG. 19 includes a format feature or characteristic of separate BS fields for delay-critical data and non-delay-critical data, respectively. In the example of FIG. 19, each BS field has a length of 4-bit. However, the sizes of the respective buffer size fields could be different depending on the network configuration sent by an RRC message.

In an exemplary implementation of the example embodiment and mode of FIG. 19, BS field for non-delay-critical data is presented when there is non-delay-critical data ahead of delay-critical data for this zone. In an exemplary, non-limiting implementation, one-bit indication instead of R field may be used to indicate the presence of BS field for non-delay-critical data. If the BS field for non-delay-critical data is not presented, the whole 1 byte (8 bits) can be used for BS field of delay-critical data. If the BS field for non-delay-critical data is present, the BS field for delay-critical data may have reduced size. In this case, most significant bit (MSB) of the original BS field for delay-critical data can be used in the BS field of the DSR MAC CE.

Thus, in the example embodiment and mode, the processor circuitry of transmitter node 22, e.g., the delay status report generator 26(15) working together with delay status report formatter 25, generates a DSR MAC CE which comprises (1) a set of information fields for at least one zone of the logical channel group; and (2) an indication of whether the set of information fields comprises a buffer size field for delay-critical data and a separate buffer size field for non-delay-critical data.

FIG. 20 shows in more detail an example implementation of a communications system in which a transmitter node generates and transmits a DSR MAC CE according to one or more formats described herein, including but not limited to the formats illustrated in FIG. 16, FIG. 17, FIG. 18, and FIG. 19. The example units and functionalities illustrated in FIG. 20 are not limiting, e.g., various units and functionalities may be omitted in some implementations and other units and functionalities not illustrated herein may be included.

FIG. 20 shows the receiver node 24 comprising receiver node processor circuitry which may comprise one or more receiver node processors 36, as well as the aforementioned receiver node transceiver circuitry 33, which may also be referred to as receiver node interface circuitry. As illustrated in FIG. 20, the receiver node's transceiver circuitry 33 may be a transmission and reception point (TRP). The transmission and reception point (TRP) 33 may further comprise transmitter circuitry and receiver circuitry. The receiver node processors 36 may comprise various entities including the delay status report processor 28(15), delay status report deformatter 29, and receiver node frame/message handler/generator 40. The node frame/message handler/generator 40 prepares and generates information including user data and messages, e.g., signaling, for transmission over the radio interface 32, and which also processes information received over the radio interface 32. The receiver node processors 36 may also comprise or realize various other entities or functionalities, such as an unillustrated radio link control, RLC, entity

FIG. 20 also shows various example constituent components and functionalities of transmitter node 22. In an example embodiment and mode, the transmitter node 22 may be a wireless terminal such as a user equipment unit, for example. For example, FIG. 20 shows transmitter node 22 as comprising memory 27 and transmitter node transceiver circuitry 30, which was illustrated as interface 30 in FIG. 5. The transmitter node transceiver circuitry 30 may also be referred to as transmitter node interface circuitry 30. The transceiver circuitry 30 in turn may comprise transmitter circuitry 52 and receiver circuitry 54. The transmitter node transceiver circuitry 30 may include antenna(e) for the wireless transmission. Transmitter circuitry 52 may include, e.g., amplifier(s), modulation circuitry and other conventional transmission equipment. Receiver circuitry 54 may comprise, e.g., amplifiers, demodulation circuitry, and other conventional receiver equipment.

FIG. 20 further shows transmitter node 22 also comprising transmitter node processor circuitry, e.g., one or more transmitter node processor(s) 60. The transmitter node 22, e.g., transmitter node processor(s) 60, may comprise the previously mentioned delay status report formatter 25, delay status report generator 26(15) and transmitter node frame or message handler/generator 62. The transmitter node 22 may also comprise user interfaces 66, including one or more user interfaces. Such user interfaces may serve for both user input and output operations, and may comprise (for example) a keyboard, a mouse, a screen such as a touch screen that can both display information to the user and receive information entered by the user. The user interface 66 may also include other types of devices, such as a speaker, a microphone, or a haptic feedback device, for example.

Example DSR MAC CE formats of the technology disclosed herein including section 3.0 hereof include but are not limited to the following:
An LCGi bit indicates presence of at least one (BT)/(E)/RT/BS set for LCG i.
A set of information fields, e.g., a (BT)/(E)/RT/BS field set, can be presented in ascending order of LCG ID for LCGi field set to 1.
Within the same LCG, (BT)/(E)/RT/BS set can be presented in ascending order of reporting threshold of each zone.
An E field indicates whether the next (BT)/(E)/RT/BS field is for the same LCG.
A Pij field indicates whether the next (BT)/(E)/RT/BS field for zone j of LCG i is present.

The generation and processing of the example formats of the technology disclosed herein including section 3.0 hereof also encompasses a computer program product in which processor circuitry or the like, such as transmitter node processor(s) 60, which may include delay status report formatter 25 and delay status report generator 26(15), and receiver node processor(s) 36, which may include delay status report format processor 28(15), execute instructions stored on a non-transient memory to perform acts to generate the formats described herein and encompassed hereby.

In terms of wireless communication, the transmitter node 22 may be either a wireless terminal such as user equipment or mobile station, or a network node. Similarly and conversely, the receiver node 24 may be either a wireless terminal such as user equipment or mobile station, or a network node. It should be understood that herein “network” may be used interchangeably with “network node”. A network node may be either a core network node or a node of a radio access network, such as a RAN access node, e.g., a base station node, for example. The wireless terminal UE may be any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, internet of things devices, etc. be any

A core network may comprise one or more core network nodes. A core network node may comprise or be realized by any suitable type of core network node entities, such as a core network management entity, e.g., an Access and Mobility Management Function (AMF). A core network and one or more of its constituent core network nodes are connected to at least one radio access network through a core-RAN interface circuit.

A radio access network in turn comprises one or more radio access network (RAN) nodes, such as a base station node. The base station node serves at least one cell. The radio access network, RAN, typically comprises plural access nodes. A base station node may have architecture such as split architecture comprising a central unit and one or more distributed units that comprise mobile termination (MT).

### Further Considerations

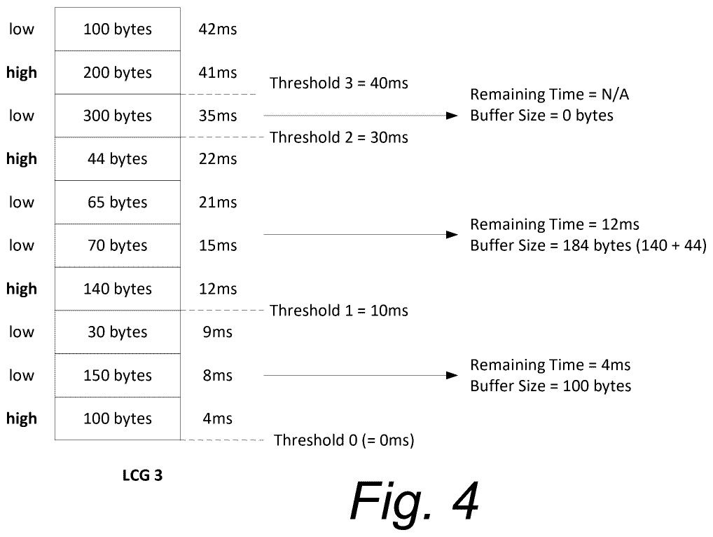

It should be understood that the various foregoing example embodiments and modes may be utilized in conjunction with one or more example embodiments and modes described herein. For example, the example embodiments and modes of all three generic aspects of the technology disclosed herein, e.g., FIG. 4, FIG. 5, FIG. 9, and FIG. 15, may be utilized in combination with one or more other example embodiments and modes disclosed herein.

Certain units and functionalities of the communications systems may be implemented by electronic machinery. For example, electronic machinery may refer to the processor circuitry described herein, such as receiver node processors 36 and transmitter node processor(s) 60. Moreover, the term “processor circuitry” is not limited to mean one processor, but may include plural processors, with the plural processors operating at one or more sites, and which may operate individually and/or collectively. Moreover, as used herein the term “server” is not confined to one server unit but may encompass plural servers and/or other electronic equipment and may be co-located at one site or distributed to different sites. With these understandings, FIG. 21 shows an example of electronic machinery, e.g., processor circuitry, as comprising one or more processors 490, program instruction memory 492; other memory 494 (e.g., RAM, cache, etc.); input/output interfaces 496 and 497, peripheral interfaces 498; support circuits 499; and busses 500 for communication between the aforementioned units. The processor(s) 490 may comprise the processor circuitries described herein, for example, receiver node processors 36 and transmitter node processor(s) 60.

A memory or register described herein may be depicted by memory 494, or any computer-readable medium, may be one or more of readily available memory such as random-access memory (RAM), read only memory (ROM), floppy disk, hard disk, flash memory or any other form of digital storage, local or remote, and is preferably of non-volatile nature, as and such may comprise memory. The support circuits 499 are coupled to the processors 490 for supporting the processor in a conventional manner. These circuits include cache, power supplies, clock circuits, input/output circuitry and subsystems, and the like.

The processes and methods of the disclosed embodiments may be implemented as a software routine. Alternatively or additionally, some or all of method steps that are disclosed therein may be performed in hardware as well as by a processor running software. As such, the embodiments may be implemented in software, as executed upon a computer system, in hardware as an application specific integrated circuit or other type of hardware implementation, or a combination of software and hardware. The software routines of the disclosed embodiments are capable of being executed on any computer operating system and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus, machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Nodes that communicate using the air interface also have suitable radio communications circuitry. Moreover, the technology disclosed herein may additionally be considered to be embodied entirely within any form of computer-readable memory, such as solid-state memory, magnetic disk, or optical disk containing an appropriate set of computer instructions that would cause a processor to carry out the techniques described herein.

The acts described herein may be performed by a software program product stored tangibly on a non-transient computer-readable medium which, when executed by one or more processors as herein mentioned, performs such acts either in whole or in part.

Moreover, each functional block or various features of the transmitter node 22 and receiver node 24 employed in each of the aforementioned embodiments may be implemented or executed by circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the technology disclosed herein is directed to solving radio communications-centric issues and is necessarily rooted in computer technology and overcomes problems specifically arising in radio communications. Moreover, the technology disclosed herein improves resource allocation and efficient data transmission in a communications system.

The technology disclosed herein encompasses one or more of the following non-limiting, non-exclusive example embodiments and modes:

Example Embodiment 1.1: A transmitter node of a telecommunications system, the transmitter node comprising:
processor circuitry configured to generate a truncated delay status report (DSR) medium access control (MAC) control element (CE), the truncated DSR MAC CE comprising only a subset of contents of a full DSR MAC CE;
interface circuitry configured to transmit the truncated DSR MAC CE over a radio interface to a receiver node of the telecommunications system.

Example Embodiment 1.2: The node of Example Embodiment 1.1, wherein the processor circuitry is configured to generate the truncated DSR MAC CE upon receipt of an uplink grant having an uplink grant size that is smaller than size of the full DSR MAC CE.

Example Embodiment 1.3: The node of Example Embodiment 1.1, wherein the processor circuitry is configured to generate the truncated DSR MAC CE to comprise a bitmap which indicates one or more logical channel groups (LCGs) comprising delay critical data.

Example Embodiment 1.4: The node of Example Embodiment 1.1, wherein the processor circuitry is configured to generate the truncated DSR MAC CE to comprise a set of information fields, for selected one(s) of the one or more logical channel groups, the set of information fields comprising a remaining time field and a buffer size field.

Example Embodiment 1.5: The node of Example Embodiment 1.4, wherein the processor circuitry is configured to select the selected one(s) of the one or more logical groups based on size of an uplink grant which is smaller than the size of the full DSR MAC CE.

Example Embodiment 1.6: The node of Example Embodiment 1.4, wherein the processor circuitry is configured to arrange, within the truncated DSR MAC CE, the sets of information fields for the selected one(s) of the one or more logical groups in a predetermined order based on an identifier of the respective logical channel groups (LCGs).

Example Embodiment 1.7: The node of Example Embodiment 1.6, further comprising memory, the memory comprising a buffer wherein packets for a selected logical channel group are stored, and wherein each of the packets for the selected logical channel group are classified in one of plural zones, the zones being differentiated based on a remaining time for the packet in the buffer before discard of the packet from the buffer, and wherein the processor circuitry is configured to
generate the truncated DSR MAC CE to include the sets of information fields for a subset of the plural zones for the selected logical channel group; and
include in the truncated DSR MAC CE an indication that delay critical data resides in other zones of the selected logical channel group for which information fields are not included in the truncated DSR MAC CE.

Example Embodiment 1.8: The node of Example Embodiment 1.6, further comprising memory, the memory comprising a buffer wherein packets for a logical channel group are stored, and wherein each of the packets for the logical channel group are classified in one of plural zones, the zones being differentiated based on a remaining time for the packet in the buffer before discard of the packet from the buffer, and wherein the processor circuitry is configured to generate the truncated DSR MAC CE to include the sets of information fields for the plural zones for the logical channel groups in a predetermined order.

Example Embodiment 1.9: The node of Example Embodiment 1.1, wherein the node is a wireless terminal which communicates over a radio interface with a network node.

Example Embodiment 1.10: A method in a node of a telecommunications system, the method comprising:
generating a truncated delay status report (DSR) medium access control (MAC) control element (CE), the truncated DSR MAC CE comprising only a subset of contents of a full DSR MAC CE;
transmitting the truncated DSR MAC CE over a radio interface to a receiver node of the telecommunications system.

Example Embodiment 1.11: A receiver node of a telecommunications system, the receiver node comprising:
interface circuitry configured to receive a truncated delay status report (DSR) medium access control (MAC) control element (CE) over a radio interface from a transmitter node of the telecommunications system
processor circuitry configured to determine from the truncated DSR MAC CE that the truncated DSR MAC CE comprises only a subset of contents of a full DSR MAC CE.

Example Embodiment 1.12: The node of Example Embodiment 1.11, wherein the truncated DSR MAC CE does not encompass one or more of the following:
at least one logical channel groups having delay critical data;
at least one zone of plural zones of a selected logical channel group, the zones being differentiated based on a remaining time for a packet in a buffer for the selected logical channel group before discarding the packet from the buffer.

Example Embodiment 1.13: The node of Example Embodiment 1.11, wherein the truncated DSR MAC CE comprises:
a bitmap which indicates one or more logical channel groups (LCGs) comprising delay critical data;
a set of information fields, for selected one(s) of the one or more logical channel groups, the set of information fields comprising a remaining time field and a buffer size field.

Example Embodiment 1.14: The node of Example Embodiment 1.13, wherein, within the truncated DSR MAC CE, the sets of information fields for the selected one(s) of the one or more logical groups are arranged in a predetermined order based on an identifier of the respective logical channel groups (LCGs).

Example Embodiment 1.15: The node of Example Embodiment 1.11, wherein the processor circuitry is configured to determine from the truncated DSR MAC CE an indication that delay critical data resides in one or more of the following:
at least one logical channel groups not reported by the truncated DSR MAC CE;
at least one zone of plural zones not reported by the truncated DSR MAC CE for a selected logical channel group, the zones being differentiated based on a remaining time for a packet in a buffer for the selected logical channel group before discarding the packet from the buffer.

Example Embodiment 2.1: A transmitter node of a telecommunications system, the transmitter node comprising:
memory comprising a buffer;
processor circuitry configured to generate a delay status report (DSR) medium access control (MAC) control element (CE) comprising a buffer size field including non-delay-critical data in the buffer which precedes in transmission order delay-critical data reported by the DSR MAC CE; and,
interface circuitry configured to transmit the DSR MAC CE over a radio interface to a receiver node of the telecommunications system.

Example Embodiment 2.2: The node of Example Embodiment 2.1, wherein the interface circuitry is further configured to receive a configuration message over the radio interface from the receiver node of the telecommunications system; and wherein the processor circuitry is configured to determine, based on the configuration message, whether to generate the buffer size field to include non-delay-critical data.

Example Embodiment 2.3: The node of Example Embodiment 2.1, wherein:
packets for a logical channel group are stored in the buffer, and wherein each of the packets for the logical channel group are classified in one of plural zones;
the processor circuitry is configured to generate the delay status report (DSR) medium access control (MAC) control element (CE) to comprise a buffer size field for one or more zones for at least one of the one or more logical channel groups reported by the DSR MAC CE, and wherein for at least one of the zones, the buffer size field reflects an amount of delay-critical data for the zone and an amount of non-delay-critical data.

Example Embodiment 2.4: The node of Example Embodiment 2.3, wherein the amount of non-delay-critical data comprises non-delay-critical data stored in the buffer timewise ahead of the last delay-critical data for the zone but not included in the buffer size of another zone.

Example Embodiment 2.5: The node of Example Embodiment 2.3, wherein the amount of non-delay-critical data comprises non-delay-critical data stored in the buffer timewise ahead of the first delay-critical data for the zone but not included in the buffer size of another zone.

Example Embodiment 2.6: The node of Example Embodiment 2.3, wherein the amount of non-delay-critical data comprises non-delay-critical data for the zone.

Example Embodiment 2.7: The node of Example Embodiment 2.3, wherein non-delay-critical data is not included in the buffer size field for a zone if it has already included in a buffer size field of another zone in the same DSR MAC CE.

Example Embodiment 2.8: A method in a transmitter node of a telecommunications system, the method comprising:
generating a delay status report (DSR) medium access control (MAC) control element (CE) to comprise a buffer size field which includes non-delay-critical data in the buffer which precedes in transmission order delay-critical data reported by the DSR MAC CE; and,
transmitting the DSR MAC CE over a radio interface to a receiver node of the telecommunications system.

Example Embodiment 2.9: A receiver node of a telecommunications system, the receiver node comprising:
interface circuitry configured to receive a delay status report (DSR) medium access control (MAC) control element (CE) over a radio interface from a transmitter node of the telecommunications system; and
processor circuitry configured to determine from the DSR MAC CE a buffer size field which includes non-delay-critical data precedes, in reception order, delay-critical data reported by the DSR MAC CE.

Example Embodiment 2.10: The node of Example Embodiment 2.9, wherein the processor circuitry is configured to generate a configuration message which configures the transmitter circuitry whereby the transmitter circuitry generates the DSR MAC CE so that the buffer size includes the non-delay-critical data in the buffer based on the configuration message.

Example Embodiment 2.11: The node of Example Embodiment 2.9, wherein:
the DSR MAC CE comprises a buffer size field for one or more zones for at least one of the one or more logical channel groups reported by the DSR MAC CE; and
the processor circuitry is configured to determine from the DSR MAC CE that the buffer size field of the DSR MAC CE for a zone reflects an amount of delay-critical data for the zone reported by the DSR MAC CE and an amount of non-delay-critical data.

Example Embodiment 2.12: The node of Example Embodiment 2.10, wherein the amount of non-delay-critical data comprises non-delay-critical data stored in a buffer timewise ahead of the last delay-critical data for the zone but not included in the buffer size of another zone.

Example Embodiment 2.13: The node of Example Embodiment 2.10, wherein the amount of non-delay-critical data comprises non-delay-critical data stored in a buffer timewise ahead of the first delay-critical data for the zone but not included in the buffer size of another zone.

Example Embodiment 2.14: The node of Example Embodiment 2.10, wherein the amount of non-delay-critical data comprises non-delay-critical data for the zone.

Example Embodiment 2.15: The node of Example Embodiment 2.10, wherein non-delay-critical data is not included in the buffer size field for a zone if it has already included in a buffer size field of another zone in the same DSR MAC CE.

Example Embodiment 3.1: A transmitter node of a telecommunications system, the transmitter node comprising:
processor circuitry configured to generate a delay status report (DSR) medium access control (MAC) control element (CE), the DSR MAC CE comprises an indication for which of plural zones of a logical channel group the DSR MAC CE comprises a set of information fields; and
interface circuitry configured to transmit the DSR MAC CE over a radio interface to a receiver node of the telecommunications system.

Example Embodiment 3.2: The node of Example Embodiment 3.1, further comprising memory, the memory comprising a buffer wherein packets for the logical channel group are stored, and wherein each of the packets for the logical channel group are classified in one of the plural zones, and wherein the zones are differentiated based on a remaining time for a packet in the buffer for the logical channel group before discarding the packet from the buffer.

Example Embodiment 3.3: The node of Example Embodiment 3.1, wherein for a same logical channel group, sets of information for the plural zones are arranged in a predetermined order of reporting in accordance with a threshold of each zone.

Example Embodiment 3.4: The node of Example Embodiment 3.1, wherein the processor circuitry is configured to generate the DSR MAC CE to comprise:
a first set of information fields for a first zone of a logical channel group reported by the DSR MAC CE; and
an indication whether the DSR MAC CE includes a set of information fields for another zone of the logical channel group.

Example Embodiment 3.5: The node of Example Embodiment 3.4, wherein the first set of information fields comprises the indication whether the DSR MAC CE includes the set of information fields for another zone of the logical channel group.

Example Embodiment 3.6: The node of Example Embodiment 3.1, the processor circuitry is further configured to generate the DSR MAC CE to comprise a bitmap corresponding to the plural zones, and wherein the DSR MAC CE includes the set of information fields for zones of the logical channel group according to the bitmap.

Example Embodiment 3.7: The node of Example Embodiment 3.1, wherein the set of information fields comprises a remaining time field and a buffer size field.

Example Embodiment 3.8: The node of Example Embodiment 3.1, wherein the node is a wireless terminal which communicates over a radio interface with a network node.

Example Embodiment 3.9: The node of Example Embodiment 3.1, wherein the DSR MAC CE further comprises a bitmap which indicates one or more logical channel groups (LCGs) comprising delay critical data.

Example Embodiment 3.10: The node of Example Embodiment 3.2, wherein, within the DSR MAC CE, the sets of information fields for the one or more logical groups are arranged in a predetermined order based on an identifier of the respective logical channel groups (LCGs).

Example Embodiment 3.11: A transmitter node of a telecommunications system, the transmitter node comprising:
processor circuitry configured to generate a delay status report (DSR) medium access control (MAC) control element (CE), the DSR MAC CE comprising:
   a set of information fields for at least one zone of the logical channel group; and
   an indication of whether the set of information fields comprises a buffer size field for delay-critical data and a separate buffer size field for non-delay-critical data;
interface circuitry configured to transmit the DSR MAC CE over a radio interface to a receiver node of the telecommunications system.

Example Embodiment 3.12: The node of Example Embodiment 3.11, wherein the indication comprises an R field of the set of information fields for the DSR MAC CE.

Example Embodiment 3.13: The node of Example Embodiment 3.11, wherein the indication comprises a one-bit field of the set of information fields for the DSR MAC CE.

Example Embodiment 3.14: The node of Example Embodiment 3.11, wherein a size of at least one of the buffer size fields for delay-critical data and a size of the separate buffer size field for the non-delay-critical data is configured according to a message received from the network node.

Example Embodiment 3.15: A method in a transmitter node of a telecommunications system, the method comprising:
generating a delay status report (DSR) medium access control (MAC) control element (CE), the DSR MAC CE comprises an indication for which of plural zones of a logical channel group the DSR MAC CE comprises a set of information fields; and
transmitting the DSR MAC CE over a radio interface to a receiver node of the telecommunications system. A method in a transmitter node of a telecommunications system, the method comprising:
generating a delay status report (DSR) medium access control (MAC) control element (CE), the DSR MAC CE comprises an indication for which of plural zones of a logical channel group the DSR MAC CE comprises a set of information fields; and
transmitting the DSR MAC CE over a radio interface to a receiver node of the telecommunications system.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” The above-described embodiments could be combined with one another. All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims.

What is claimed IS:

1. A transmitter node of a telecommunications system, the transmitter node comprising:
processor circuitry configured to generate a truncated delay status report (DSR) medium access control (MAC) control element (CE), the truncated DSR MAC CE comprising only a subset of contents of a full DSR MAC CE;
interface circuitry configured to transmit the truncated DSR MAC CE over a radio interface to a receiver node of the telecommunications system.

2. The node of claim 1, wherein the processor circuitry is configured to generate the truncated DSR MAC CE upon receipt of an uplink grant having an uplink grant size that is smaller than size of the full DSR MAC CE.

3. The node of claim 1, wherein the processor circuitry is configured to generate the truncated DSR MAC CE to comprise a bitmap which indicates one or more logical channel groups (LCGs) comprising delay critical data.

4. The node of claim 1, wherein the processor circuitry is configured to generate the truncated DSR MAC CE to comprise a set of information fields, for selected one(s) of the one or more logical channel groups, the set of information fields comprising a remaining time field and a buffer size field.

5. The node of claim 4, wherein the processor circuitry is configured to select the selected one(s) of the one or more logical groups based on size of an uplink grant which is smaller than the size of the full DSR MAC CE.

6. The node of claim 4, wherein the processor circuitry is configured to arrange, within the truncated DSR MAC CE, the sets of information fields for the selected one(s) of the one or more logical groups in a predetermined order based on an identifier of the respective logical channel groups (LCGs).

7. The node of claim 6, further comprising memory, the memory comprising a buffer wherein packets for a selected logical channel group are stored, and wherein each of the packets for the selected logical channel group are classified in one of plural zones, the zones being differentiated based on a remaining time for the packet in the buffer before discard of the packet from the buffer, and wherein the processor circuitry is configured to
generate the truncated DSR MAC CE to include the sets of information fields for a subset of the plural zones for the selected logical channel group; and
include in the truncated DSR MAC CE an indication that delay critical data resides in other zones of the selected logical channel group for which information fields are not included in the truncated DSR MAC CE.

8. The node of claim 6, further comprising memory, the memory comprising a buffer wherein packets for a logical channel group are stored, and wherein each of the packets for the logical channel group are classified in one of plural zones, the zones being differentiated based on a remaining time for the packet in the buffer before discard of the packet from the buffer, and wherein the processor circuitry is configured to generate the truncated DSR MAC CE to include the sets of information fields for the plural zones for the logical channel groups in a predetermined order.

9. The node of claim 1, wherein the node is a wireless terminal which communicates over a radio interface with a network node.

10. A method in a node of a telecommunications system, the method comprising:
generating a truncated delay status report (DSR) medium access control (MAC) control element (CE), the truncated DSR MAC CE comprising only a subset of contents of a full DSR MAC CE;
transmitting the truncated DSR MAC CE over a radio interface to a receiver node of the telecommunications system.

11. A receiver node of a telecommunications system, the receiver node comprising:
interface circuitry configured to receive a truncated delay status report (DSR) medium access control (MAC) control element (CE) over a radio interface from a transmitter node of the telecommunications system
processor circuitry configured to determine from the truncated DSR MAC CE that the truncated DSR MAC CE comprises only a subset of contents of a full DSR MAC CE.

12. The node of claim 11, wherein the truncated DSR MAC CE does not encompass one or more of the following:
at least one logical channel groups having delay critical data;
at least one zone of plural zones of a selected logical channel group, the zones being differentiated based on a remaining time for a packet in a buffer for the selected logical channel group before discarding the packet from the buffer.

13. The node of claim 11, wherein the truncated DSR MAC CE comprises:
a bitmap which indicates one or more logical channel groups (LCGs) comprising delay critical data;
a set of information fields, for selected one(s) of the one or more logical channel groups, the set of information fields comprising a remaining time field and a buffer size field.

14. The node of claim 13, wherein, within the truncated DSR MAC CE, the sets of information fields for the selected one(s) of the one or more logical groups are arranged in a predetermined order based on an identifier of the respective logical channel groups (LCGs).

15. The node of claim 11, wherein the processor circuitry is configured to determine from the truncated DSR MAC CE an indication that delay critical data resides in one or more of the following:
at least one logical channel groups not reported by the truncated DSR MAC CE;
at least one zone of plural zones not reported by the truncated DSR MAC CE for a selected logical channel group, the zones being differentiated based on a remaining time for a packet in a buffer for the selected logical channel group before discarding the packet from the buffer.
